(19) United States
(12) Patent Application Publication
(10) Pub. No.: US 2009/0040410 A1
(43) Pub. Date: Feb. 12, 2009

(54) LIQUID CRYSTAL DISPLAY

(76) Inventors: Hwa-Sung Woo, Suwon-si (KR); Sung-Woon Kim, Suwon-si (KR); Hee-Seop Kim, Hwaseong-si (KR)

Correspondence Address: MACPHERSON KWOK CHEN & HEID LLP, 2033 GATEWAY PLACE, SUITE 400, SAN JOSE, CA, 95110, US

(21) Appl. No.: 12/187,195

(22) Filed: Aug. 6, 2008

(30) Foreign Application Priority Data
Aug. 7, 2007 (KR) 10-2007-0078925
Jul. 11, 2008 (KR) 10-2008-067762

(51) Int. Cl. G02F 1/136

(52) U.S. Cl. 349/43

(57) ABSTRACT

A device and method for improving the uniformity of color and luminance of images displayed in a transmissive region and a reflective region of a liquid crystal display are presented. The phase difference value of light for displaying images in the reflective and transmissive regions is the same with respect to one pixel.

The phase difference value of the liquid crystal layer in the reflective region is half of the phase difference value of the liquid crystal layer in the transmissive region, in the range of from 25% to 75%, when considering the exemplary embodiments and path differences of the light. Also, a λ/4 plate having a slow axis forming a predetermined angle with the transmissive axis of the polarizer is formed inside the upper substrate and the lower substrate to display the same images in the reflective region and the transmissive region.

### CROSS-REFERENCE TO RELATED APPLICATION

This application claims priority to and the benefit of Korean Patent Application No. 10-2007-0078925 filed in the Korean Intellectual Property Office on Aug. 7, 2007 and Korean Patent Application No. 10-2008-0067762 filed in the Korean Intellectual Property Office on Jul. 11, 2008, the entire contents of which are incorporated herein by reference.

### BACKGROUND OF THE INVENTION

(a) Field of the Invention

The present invention relates to a transflective liquid crystal display using biaxial liquid crystal material.

(b) Description of the Related Art

Liquid crystal displays (LCDs) are one of the most widely used flat panel displays, and an LCD includes a pair of panels provided with field-generating electrodes, such as pixel electrodes and a common electrode, and a liquid crystal (LC) layer interposed between the two panels. The LCD displays images by applying voltages to the field-generating electrodes to generate an electric field in the LC layer that determines the orientations of LC molecules therein to adjust polarization of incident light.

In general, LCDs are manufactured using uniaxial liquid crystal material.

The uniaxial liquid crystal has a characteristic that the refractive index values of two axis directions among three axis directions are the same, but the refractive index value of the remaining axis direction (this is referred to as an optical axis in the uniaxial liquid crystal) is different from the two values.

When the progression direction of light passing through the uniaxial liquid crystal layer is in the optical axis direction of the liquid crystal molecules, because phase differences are not generated between the wave components of the light, the polarization state of the light passing through the liquid crystal layer is not changed. However, when the progressing direction of the light passing through the uniaxial liquid crystal layer is not in the optical axis direction of the liquid crystal molecules, phase differences are generated between the wave components of the light such that the polarization state of the light passing through the liquid crystal layer is changed.

On the other hand, because the liquid crystal molecules have dielectric anisotropy, the optical axis direction of the liquid crystal molecules may be controlled by an electric field.

Accordingly, the variation of the optical axis direction of the liquid crystal layer may be controlled by appropriately controlling the electric field such that the variation of the polarization state of the light passing through the liquid crystal layer may be controlled.

Since there are two values of the refractive index that are considered when manufacturing the LCD using the uniaxial liquid crystal, it is easy to adjust the polarization component of the light using the electric field.

However, when using the uniaxial liquid crystal, because it is possible to control the phase difference for the wave component of the light by only adjusting the optical axis direction according to the long axis of each liquid crystal molecule, it is disadvantageous to use the uniaxial liquid crystal in a response speed aspect, and it is also difficult to manufacture various types of LCDs.

The above information disclosed in this Background section is only for enhancement of understanding of the background of the invention and therefore it may contain information that does not form the prior art that is already known in this country to a person of ordinary skill in the art.

### SUMMARY OF THE INVENTION

In light of the foregoing, it is desirable to provide a transflective liquid crystal display using a biaxial liquid crystal material.

A liquid crystal display using biaxial (the refractive index values of three axis directions are different thereby having two optical axis) liquid crystal material according the present invention includes a pixel area having a transmissive region and a reflective region, wherein pixel electrodes and common electrodes are formed on the same substrate, and the phase difference value of the reflective region a half of the phase difference value of the transmissive region.

Here, the phase difference value may be referred as Δnd, where Δn=nₑ−nₒ and d is a cell gap.

The phase difference value of the liquid crystal layer in the reflective region is in the range of 25% to 75% of the phase difference value of the liquid crystal layer in the transmissive region, when considering the exemplary embodiments and the path differences of the light.

Also, a λ/4 plate having a slow axis forming a predetermined angle with the transmissive axis of the polarizer is used to display the same images in the reflective region and the transmissive region.

More particularly, a liquid crystal display according to an exemplary embodiment of the present invention includes a thin film transistor array panel, a counter display panel facing the thin film transistor array panel, and a liquid crystal layer disposed between the thin film transistor array panel and the counter display panel and including biaxial liquid crystal molecules. A pixel area displaying images includes a transmissive region and a reflective region, and the phase difference value of the liquid crystal layer in the reflective region is in the range of 25% to 75% of the phase difference value of the liquid crystal layer in the transmissive region.

The phase difference value of the liquid crystal layer in the reflective region may be half of the phase difference of the liquid crystal layer in the transmissive region.

At least one selected from the cell gap, the magnitude of the pixel voltage, and the direction of the electric field for the liquid crystal rubbing direction may be different between the reflective region and the transmissive region.

A first thin film transistor and a second thin film transistor may be disposed in the pixel area, first pixel electrodes connected to the first thin film transistor and having a comb shape may be disposed in the reflective region, and second pixel electrodes connected to the second thin film transistor and having a comb shape may be disposed in the transmissive region. The first pixel electrodes and the second pixel electrodes may be parallel to each other, and the liquid crystal display may further include common electrodes parallel to the first pixel electrodes and the second pixel electrodes and disposed between the first and second pixel electrodes.

A thin film transistor formed in each pixel area, first pixel electrodes disposed in the reflective region, and second pixel electrodes disposed in the transmissive region may be further included, wherein the second pixel electrodes are connected to thin film transistors and the first pixel electrode and the second pixel electrode may be capacitively coupled to each other.

Connecting electrodes connected to the second pixel electrodes may be included, wherein the connecting electrodes and the first pixel electrodes are overlapped with each other for the capacitive coupling.

A thin film transistor, pixel electrodes, and common electrodes formed in the pixel area may be included, wherein the pixel electrodes may include a transmissive region portion disposed in the transmissive region and a reflective region portion disposed in the reflective region, the common electrodes may include a transmissive region portion disposed in the transmissive region and a reflective region portion disposed in the reflective region, and the reflective region portions of the pixel electrodes and the common electrodes may not be perpendicular or parallel with respect to the edges of the pixel area, and may form a predetermined angle therewith.

The transmissive region portions of the pixel electrodes and the common electrodes may be perpendicular or parallel with respect to the edges of the pixel area.

The reflective region portions of the pixel electrodes and the common electrodes may be parallel to each other, and the transmissive region portions of the pixel electrodes and the common electrodes may be parallel to each other.

A reflector having a plurality of openings and formed on one of the thin film transistor array panel and the counter display panel may be included.

The openings define the transmissive region.

Upper and lower polarizers are attached to the outer surface of the thin film transistor array panel and the counter display panel, and a first λ/4 plate that is an upper portion of the reflector, that is disposed in the reflection region, and that is a phase retardation film for changing the line-polarized light incident by 45 degree into the circle-polarized light may be further included.

The upper and lower polarizers may include a transmissive axis, the transmissive axis of the upper polarizer may be perpendicular to the transmissive axis of the lower polarizer, the first λ/4 plate may include a slow axis, and the slow axis of the first λ/4 plate may form 45 degrees with the transmissive axis of the upper and lower polarizers.

A compensation film attached on at least one between the thin film transistor array panel and the lower polarizer, and the counter display panel and the upper polarizer, may be further included.

The compensation film may have a slow axis parallel to the transmissive axis of the polarizer close to the compensation film.

Upper and lower polarizers attached on the outer surfaces of the thin film transistor array panel and the counter display panel, a first λ/4 plate that is above the reflector and formed on the reflective region and the transmissive region, and a second λ/4 plate that is a below the reflector and formed on the reflective region and the transmissive region, may be further included.

The upper polarizer and the lower polarizer may each have a transmissive axis, the transmissive axis of the upper polarizer is perpendicular to the transmissive axis of the lower polarizer, the first λ/4 plate and the second λ/4 plate have a slow axis, the slow axis of the first λ/4 plate may be perpendicular to the slow axis of the second λ/4 plate, and the slow axis of the first and second λ/4 plates may form 45 degrees with the transmissive axis of the upper and lower polarizers.

A compensation film attached on at least one between the thin film transistor array panel and the lower polarizer, and the counter display panel and the upper polarizer, may be further included.

The compensation film may be attached between the second λ/4 plate and the lower polarizer.

The compensation film may have a slow axis parallel to the transmissive axis of the polarizer close to the compensation film.

A liquid crystal display according to an exemplary embodiment of the present invention includes a thin film transistor array panel, a counter display panel facing the thin film transistor array panel, and a liquid crystal layer formed between the thin film transistor array panel and the counter display panel and including biaxial liquid crystal molecules, wherein a pixel area displaying images includes a transmissive region and a reflective region, and the phase difference value of the light for displaying images in the reflective region is the same as the phase difference value of the light for displaying images in the transmissive region with respect to one pixel.

When the liquid crystal layer is applied with a predetermined voltage, the voltage applied to the reflective region may be different from the voltage of the the transmissive region for the value of the transmittance of the light in the transmissive region with the same as the value of the transmittance of the light in the reflective region.

An inner λ/4 plate formed between the thin film transistor array panel and the counter display panel, and at least formed in the reflective region, may be further included.

In the transflective liquid crystal display including the biaxial liquid crystal molecules, the liquid crystal display is manufactured to have the same phase difference for the light for displaying the images in the reflective region as the phase difference for the light for displaying the images in the transmissive region.

As a result, the color and the luminance of the images displayed in the reflective region and the transmissive region are the same, thereby improving the quality of the display device.

### BRIEF DESCRIPTION OF THE DRAWINGS

FIG. 1 is a schematic view of a biaxial liquid crystal molecule according to an exemplary embodiment of the present invention.

FIG. 2 is a layout view of a liquid crystal display according to a first exemplary embodiment of the present invention.

FIG. 3 is a cross-sectional view of the liquid crystal display shown in FIG. 2 taken along the line III-III.

FIG. 4 is a layout view of a liquid crystal display according to a second exemplary embodiment of the present invention.

FIG. 5 and FIG. 6 are cross-sectional views of the liquid crystal display shown in FIG. 4 taken along the lines V-V and VI-VI.

FIG. 7 is a layout view of a liquid crystal display according to a third exemplary embodiment of the present invention.

FIG. 8 is a cross-sectional view of the liquid crystal display shown in FIG. 7 taken the line VIII-VIII.

FIG. 9 is a layout view of a liquid crystal display according to a fourth exemplary embodiment of the present invention.

FIG. 10 is a cross-sectional view of the liquid crystal display shown in FIG. 9 taken the line X-X.

FIG. 11 is a view showing an enlarged electrode structure in the reflective region of FIG. 9.

FIG. 12 is a view of a structure of a liquid crystal display according to the fifth exemplary embodiment of the present invention.

FIG. 13 and FIG. 14 are views showing the polarization state of the light when displaying images in the liquid crystal display shown in FIG. 12.

FIG. 15 is a view of a structure of a liquid crystal display according to the sixth exemplary embodiment of the present invention.

FIG. 16 and FIG. 17 are views showing the polarization state of the light when displaying images in the liquid crystal display shown in FIG. 15.

FIG. 18 is a view of a structure of a liquid crystal display according to the seventh exemplary embodiment of the present invention.

FIG. 19 is a view of a structure of a liquid crystal display according to the eighth exemplary embodiment of the present invention.

### DETAILED DESCRIPTION OF THE EMBODIMENTS

The present invention is described more fully hereinafter with reference to the accompanying drawings, in which exemplary embodiments of the invention are shown.

As those skilled in the art would realize, the described embodiments may be modified in various different ways, all without departing from the spirit or scope of the present invention.

In the drawings, the thickness of layers, films, panels, regions, etc., are exaggerated for clarity.

Like reference numerals designate like elements throughout the specification.

It will be understood that when an element such as a layer, film, region, or substrate is referred to as being “on” another element, it can be directly on the other element or intervening elements may also be present.

In contrast, when an element is referred to as being “directly on” another element, there are no intervening elements present.

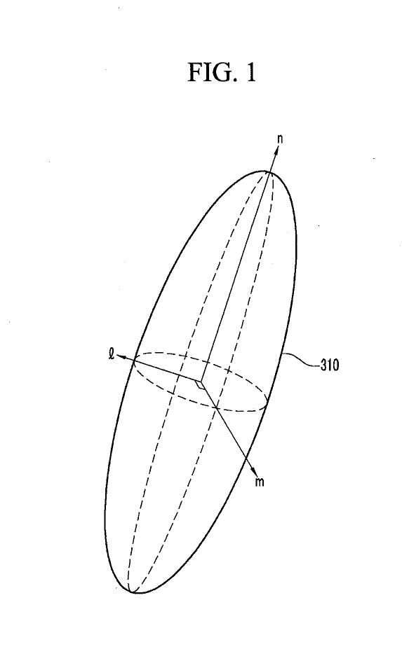

Firstly, a biaxial liquid crystal according to an exemplary embodiment of the present invention will be described in detail with reference to FIG. 1.

FIG. 1 is a perspective view of a biaxial liquid crystal molecule which illustrates the refractive index ellipsoid of a biaxial liquid crystal molecule.

As shown in FIG. 1, a biaxial liquid crystal molecule 310 according to an exemplary embodiment of the present invention includes three optical axes n, m, and l that are perpendicular to each other.

The refractive indexes of the l-axis, the m-axis, and the n-axis directions are different.

The actual structure of the liquid crystal molecule 310 may be varied in accordance with a biaxial material used. The chemical structure of the biaxial liquid crystal molecule 310 may have various structures such as a bent shape of a “V” and a crossed shape. The biaxial liquid crystal molecule comprises a biaxial nematic liquid crystal having a nematic phase.

When applying a driving voltage, the driving voltage influences and forces the liquid crystal molecule 310 in various directions based on the dielectric rate of each direction of the liquid crystal.

In the present exemplary embodiment, a horizontal rotation movement of the biaxial liquid crystal molecule 310 is described.

That is to say, the electric field is formed in the horizontal direction, and the direction of the electric field and the rubbing direction of the liquid crystal molecule 310 causes a predetermined angle. If the electric field is applied, the liquid crystal molecule 310 is horizontally rotated according to the direction of the electric field.

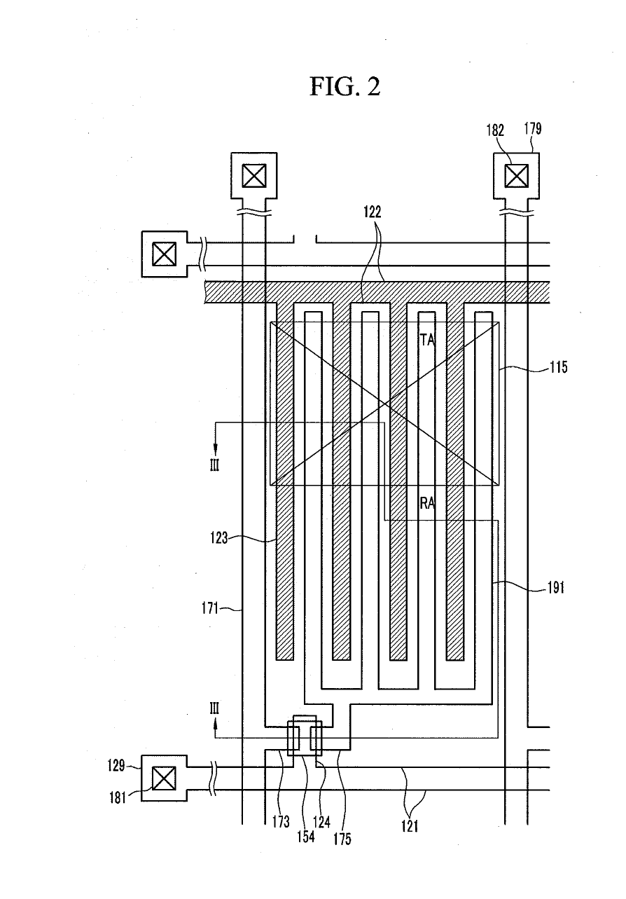

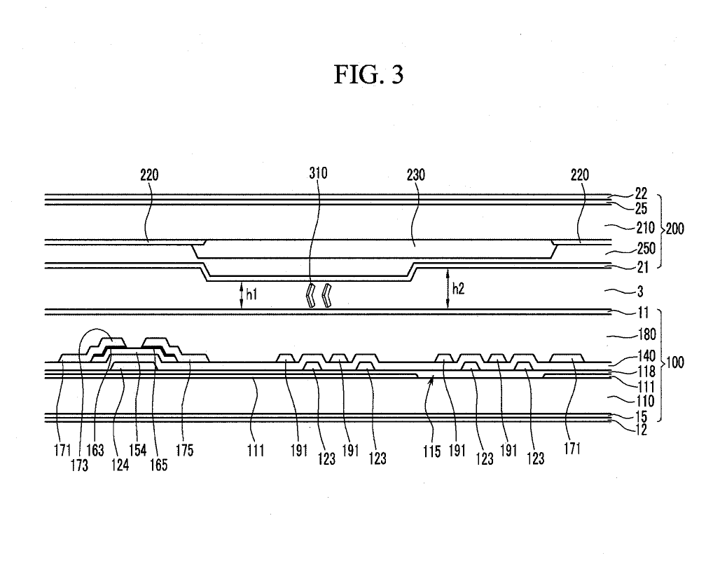

A liquid crystal display including the above-described biaxial liquid crystal molecules according to a first exemplary embodiment of the present invention is described in detail with reference to FIG. 2 and FIG. 3.

In the first exemplary embodiment, a phase difference value of a reflective region becomes half of the phase difference value of a transmissive region by controlling a cell gap value for the phase difference values.

FIG. 2 is a layout view of a liquid crystal display according to the first exemplary embodiment of the present invention, and FIG. 3 is a cross-sectional view of the liquid crystal display shown in FIG. 2 taken along the line III-III.

A liquid crystal display according to the first exemplary embodiment of the present invention includes a thin film transistor array panel 100 having a thin film transistor, a counter display panel 200 facing thereto, and a liquid crystal layer 3 formed therebetween.

Firstly, the thin film transistor array panel 100 is described below.

A reflector 111 is formed an insulating substrate 110.

The reflector 111 includes a plurality of openings 115, and the openings 115 define a plurality of regions TA in pixel areas, where light incident from the lower side is transmitted to display images.

The reflector 111 occupies the whole display area of the insulating substrate 110 except for the openings 115.

The regions occupied by the reflector 111 in the pixel area are reflective regions RA where light incident from the upper side is reflected to display the images.

An insulating layer 118 is formed on the reflector 111 and the insulating substrate 110.

The insulating layer 118 is preferably made of an inorganic material or an organic insulating material.

A plurality of gate lines 121 and common electrode lines 122 are formed on the insulating layer 118.

The gate lines 121 transmit gate signals, and extend in the horizontal direction.

Each gate line 121 includes a plurality of gate electrodes 124 protruding upward and an end portion 129 having a large area for connection with another layer or an external driving circuit.

The common electrode lines 122 extend substantially in a transverse direction and parallel to the gate lines, and are supplied with a predetermined voltage.

Each common electrode line 122 includes a plurality of common electrodes 123 that are extended in the vertical direction in the pixel area.

A gate insulating layer 140 is formed on the whole surface of the substrate including the gate lines 121 and the common electrode lines 131, and a plurality of semiconductors 154 preferably made of amorphous silicon or polysilicon are formed on the insulating layer 140.

The semiconductors 154 are disposed on the gate electrodes 124.

A plurality of pairs of ohmic contacts 163 and 165 preferably made of a material such as n+ hydrogenated amorphous silicon are formed on the semiconductors 154.

A plurality of data lines 171 and a plurality of pixel electrodes 191 are formed on the ohmic contacts 163 and 165 and the gate insulating layer 140.

The data lines 171 for transmitting data signals substantially extend in a vertical direction, thereby crossing the gate lines 121 and the common electrode lines 122.

Each of data lines 171 includes a plurality of source electrodes 173 extending toward the gate electrodes 124, and an end portion 179 having a large area for connection with another layer or an external driving circuit.

The drain electrodes 175 opposite to the source electrodes 173 with respect to the gate electrode 124 are extended and connected to the pixel electrodes 191.

The pixel electrodes 191 are disposed in a pixel defined by the gate lines 121 and the data lines 171, and include a plurality of comb portions disposed between the neighboring common electrodes 123 and a connection portion for connecting the comb portions.

The comb portions of the pixel electrodes 191 are disposed parallel to the common electrode 123 such that a horizontal electric field is formed.

A gate electrode 124, a source electrode 173, and a drain electrode 175 along with the semiconductor 154 form a thin film transistor having a channel formed in the semiconductor 154 disposed between the source electrode 173 and the drain electrode 175.

A passivation layer 180 is formed on the data lines 171 and the pixel electrodes 191.

The passivation layer 180 has a plurality of contact holes 182 exposing the end portions 179 of the data lines 171, and the passivation layer 180 and the gate insulating layer 140 have a plurality of contact holes 181 exposing the end portions of the gate lines 121.

A lower alignment layer 11 is formed on the passivation layer 180.

On the opposite side of substrate 110, a lower polarizer 12 is attached to the lower surface.

Also, a lower phase difference film 15 may be provided on the inside or outside of the insulating substrate 110, and the lower phase difference film 15 attached to the outside is shown in FIG. 3.

The lower phase difference film 15 include a λ/4 plate, and further include a λ/2 plate or a compensation film.

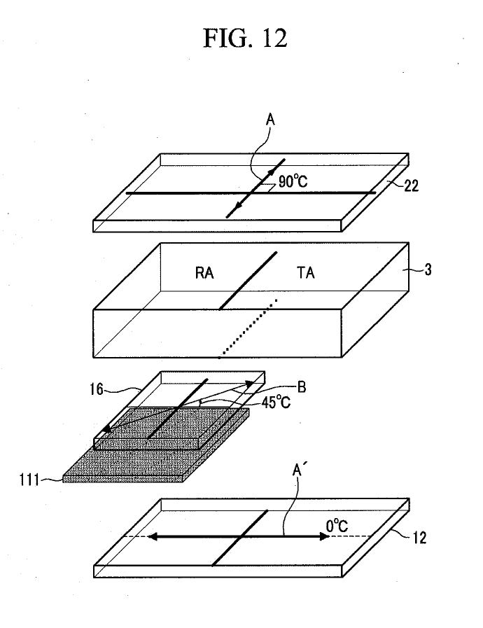

The phase difference film will be described in further detail with reference to FIG. 12 below.

Next, the counter display panel 200 facing the thin film transistor array panel 100 will be described.

A light blocking member 220, also referred to as a black matrix is formed on an insulating substrate 210, and a plurality of color filters 230 are also formed thereon. The color filters 230 are disposed substantially in the areas enclosed by the light blocking member 220.

The color filters 230 cover the pixel areas.

The color filters 230 may have a thickness difference between the transmissive region TA and the reflective region RA.

That is to say, when displaying the images, the light transmits through the color filters 230 once in the transmissive region TA, but the light transmits through the color filters 230 twice in the reflective region RA such that the color filters 230 disposed on the transmissive region TA may have the thicker thickness than the color filters 230 disposed on the reflective region RA to remove the impression of color differences.

An overcoat 250 is formed on the color filters 230.

The overcoat 250 has a thickness difference between the transmissive region TA and the reflective region RA.

As a result, when combining the thin film transistor array panel 100 and the counter display panel 200, the cell gap between the display panels 100 and 200 is different between the transmissive region TA and the reflective region RA.

That is to say, the cell gap h1 in the reflective region RA is narrower than the cell gap h2 of the transmissive region TA.

In general, the cell gap h1 of the reflective region RA is half the cell gap h2 of transmissive region TA, and an error of the cell gap h2 in the transmissive region TA may be generated with a degree of about 25% according to the exemplary embodiment.

That is to say, the cell gap h1 of the reflective region RA may be in the range of from more than 25% to less than 75% of the cell gap h2 of the transmissive region TA.

An upper alignment layer 21 is formed on the overcoat 250, and an upper polarizer 22 is attached to the outer surface of the insulating substrate 210.

Also, an upper phase difference film 25 may be provided on the inside or outside of the insulating substrate 210, and the phase difference film 25 attached to the outside is shown in FIG. 3.

The upper phase difference film 25 include a λ/4 plate, and further include a λ/2 plate or a compensation film.

The phase difference film will be described in further detail with reference to FIG. 12 below.

The alignment layers 11 and 21 are rubbed at a predetermined angle φ of about from 0 degrees to 50 degrees with respect to the pixel electrodes 191 and the common electrode 123 that are parallel to each other.

A liquid crystal layer 3 including a plurality of biaxial liquid crystal molecules 310 is formed between the thin film transistor array panel 100 and the counter display panel 200.

In the above first exemplary embodiment, a phase difference value of the reflective region RA is half of the phase difference value of the transmissive region TA by controlling the cell gap value for the phase difference values.

In this way, the phase difference between the reflective region and the transmissive region depends on the path difference of the light for displaying the images.

At the reflective region RA, light incident from the outside passes through the liquid crystal layer 3 and is then reflected by the reflector 111 and again passes through the liquid crystal layer 3 to display the images.

However, at the transmitting region (TA), light incident from the lower side transmits through the liquid crystal layer 3 once to display the images.

Therefore, because the numbers of passages of the light through the liquid crystal layer 3 between the regions are different, the phase differences of the light may be different in the two regions.

However, the structure of the liquid crystal display is changed in the present invention such that the values of the phase difference of the light for displaying the images are adjusted to be the same in the reflective region RA and the transmissive region TA, to thereby display the images having the same grayscale level.

Next, an exemplary embodiment of adjusting a refractive index n for the same phase difference values in the reflective region RA and the transmissive region TA will be described.

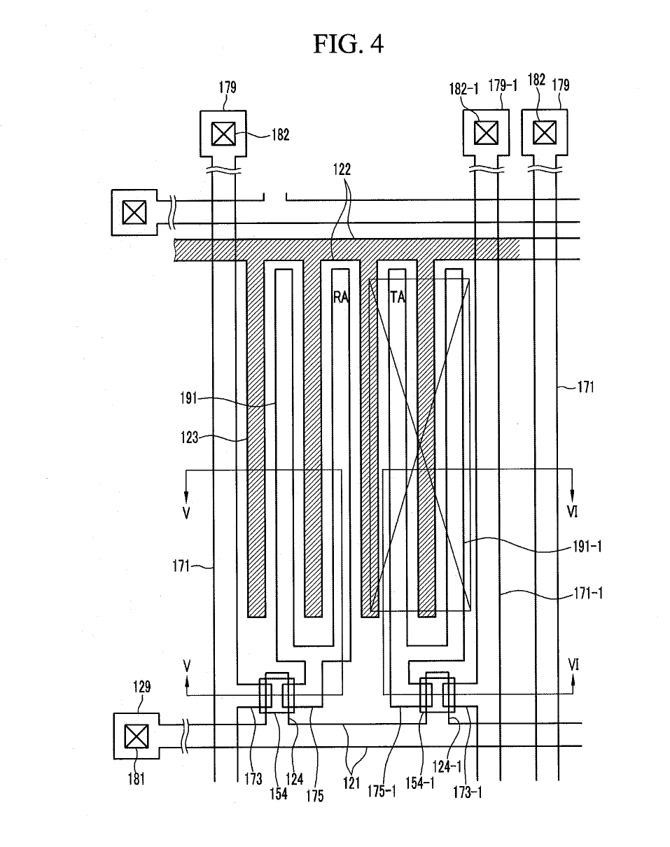

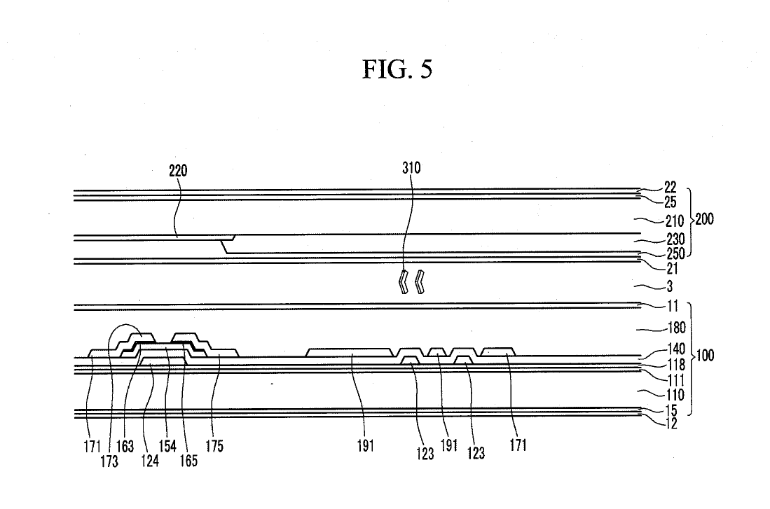

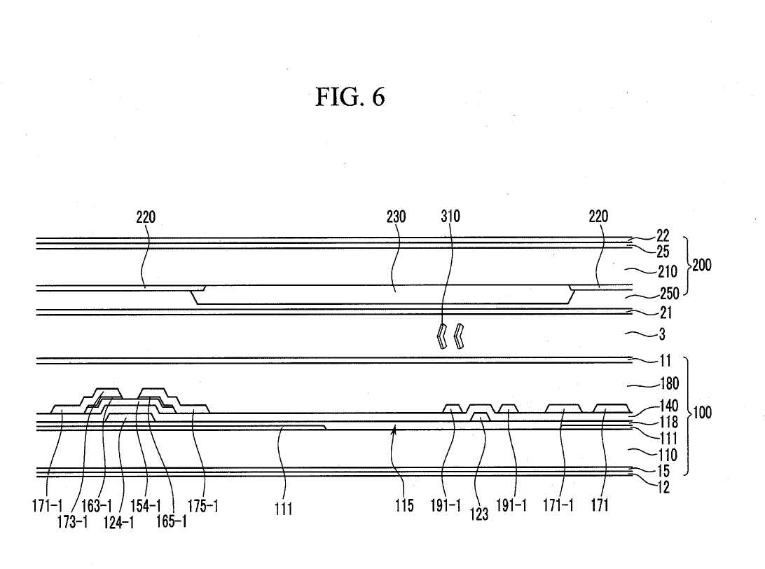

FIG. 4 is a layout view of a liquid crystal display according to the second exemplary embodiment of the present invention, and FIG. 5 and FIG. 6 are cross-sectional views of the liquid crystal display shown in FIG. 4 taken along the lines V-V and VI-VI, respectively.

In the second exemplary embodiment, two data lines are used to apply the different voltages to two pixel electrodes to control the data voltages such that the arrangements of the liquid crystal molecules 310 in the reflective region RA and the transmissive region TA become different. Accordingly, the phase difference value of the reflective region RA becomes half of the phase difference value of the region TA in this exemplary embodiment.

For this purpose, two data lines 171 and 171-1 and two transistors are disposed in one pixel area, and two pixel electrodes 191 and 191-1 are also disposed in one pixel area.

One pixel electrode 191 of two pixel electrodes, and the associated transistor and the data line 171 connected thereto, control the reflective region RA, and the other pixel electrode 191-1, and the associated transistor and the data line 171-1, control the transmissive region TA.

This will be described in detail with reference to FIGS. 4 to 6.

A liquid crystal display according to the second exemplary embodiment of the present invention includes a thin film transistor array panel 100 including a thin film transistor, a counter display panel 200, and a liquid crystal layer 3 formed therebetween.

Firstly, the thin film transistor array panel 100 is described.

A reflector 111 is formed an insulating substrate 110.

The reflector 111 includes a plurality of openings 115, and the openings 115 define a plurality of regions TA in pixel areas, where the light incident from the lower side is transmitted to display images.

The reflector 111 occupies the whole display area of the insulating substrate 110 except for the openings 115.

The regions occupied by the reflector 111 in the pixel area are reflective regions RA where the light incident from the upper side is reflected to display the images.

In the second exemplary embodiment, the openings 115 corresponding to the transmissive region TA are disposed on the right side of the pixel area as viewed in FIG. 4 such that the second exemplary embodiment has a different structure from the first exemplary embodiment having the transmissive region TA disposed in the upper side of the pixel area.

However, the openings 115 corresponding to the transmissive region TA may also be disposed in the upper side in the pixel area in the second exemplary embodiment like in the first exemplary embodiment.

An insulating layer 118 is formed on the reflector 111 and the insulating substrate 110.

The insulating layer 118 is preferably made of an organic material or an organic insulating material.

A plurality of gate lines 121 and a plurality of common electrode lines 122 are formed on the insulating layer 118.

The gate lines 121 transmit gate signals, and extend in the horizontal direction.

Each gate line 121 includes a plurality of pairs of gate electrodes 124 and 124-1 protruding upward and an end portion 129 having a large area for connection with another layer or an external driving circuit.

The common electrode lines 122 extend substantially in a transverse direction and parallel to the gate lines, and are supplied with a predetermined voltage.

Each common electrode line 122 includes a plurality of common electrodes 123 that are extended in the vertical direction in the pixel area.

A gate insulating layer 140 is formed on the whole surface of the substrate including the gate lines 121 and the common electrode line 122, and a plurality of semiconductors 154 and 154-1 preferably made of amorphous silicon or polysilicon are formed on the gate insulating layer 140.

The semiconductors 154 and 154-1 are respectively disposed on the gate electrodes 124.

A plurality of pairs of ohmic contacts 163 and 165, and 163-1 and 165-1, that are preferably made of a material such as n+ hydrogenated amorphous silicon, are respectively formed on the semiconductors 154 and 154-1.

A plurality of pairs of data lines 171 and 171-1 and a plurality of pairs of pixel electrodes 191 and 191-1 are formed on the ohmic contacts 163 and 165, and 163-1 and 165-1, respectively, and on the gate insulating layer 140.

The data lines 171 and 171-1 for transmitting data signals extend substantially in a vertical direction, thereby crossing the gate lines 121 and the common electrode lines 122. The data lines 171 and 171-1 transmit different voltages from each other.

Each of data lines 171 and 171-1 respectively includes a plurality of source electrodes 173 and 173-1 respectively extending toward the gate electrodes 124 and 124-1, and end portions 179 and 179-1 having a large area for connection with another layer or an external driving circuit.

The drain electrodes 175 and 175-1 opposite to the source electrodes 173 and 173-1 with respect to the gate electrodes 124 and 124-1 are respectively extended and connected to the pixel electrodes 191 and 191-1.

Two pixel electrodes 191 and 191-1 are respectively disposed in a pixel defined by the gate lines 121 and the data lines 171 and 171-1, and respectively include a plurality of comb portions disposed between the neighboring common electrodes 123 and a connection portion for connecting the comb portions

The two pixel electrodes 191 and 191-1 are separated from each other, and the comb portions of the pixel electrodes 191 and 191-1 are disposed parallel to the common electrode 123 such that a horizontal electric field is formed.

The gate electrode 124, the source electrode 173, and the drain electrode 175 along with the semiconductor 154 form one thin film transistor, and the gate electrode 124-1, the source electrode 173-1, and the drain electrode 175-1 along with the semiconductor 154-1 also form one thin film transistor.

A passivation layer 180 is formed on the data lines 171 and 171-1 and on the pixel electrodes 191 and 191-1.

The passivation layer 180 has a plurality of contact holes 182 and 182-1 exposing the end portions 179 and 179-1 of the data lines 171 and 171-1, and the passivation layer 180 and the gate insulating layer 140 have a plurality of contact holes 181 exposing the end portions of the gate lines 121.

A lower alignment layer 11 is formed on the passivation layer 180.

On the other hand, a lower polarizer 12 is attached to the lower surface of the insulating substrate 110.

Also, a lower phase difference film 15 may be provided on the inside or outside of the insulating substrate 110, and the lower phase difference film 15 attached to the outside is shown in FIG. 3.

The lower phase difference film 15 includes a λ/4 plate, and further includes a λ/2 plate or a compensation film.

The phase difference film will be described in further detail with reference to FIG. 12 below.

Next, the counter display panel 200 facing the thin film transistor array panel 100 will be described.

A blocking member 220 called a black matrix is formed on an insulating substrate 210, and a plurality of color filters 230 are also formed thereon. The color filters 230 are disposed substantially in the areas enclosed by the light blocking member 220.

The color filters 230 cover the pixel areas.

On the hand, the color filters 230 may have a thickness difference between the transmissive region TA and the reflective region RA.

That is to say, when displaying the images, the light transmits through the color filters 230 once in the transmissive region TA, but the light transmits through the color filters 230 twice in the reflective region RA such that the color filters 230 disposed on the transmissive region TA may have a thicker thickness than the color filters 230 disposed on the reflective region RA to remove the impression of color differences.

An overcoat 250 preferably made of an organic material is formed on the color filters 230.

An upper alignment layer 21 is formed on the overcoat 250, and an upper polarizer 22 is attached to the outer surface of the insulating substrate 210.

Also, an upper phase difference film 25 may be provided on the inside or outside of the insulating substrate 210, and the phase difference film 25 attached to the outside is shown in FIG. 3.

The upper phase difference film 25 include a λ/4 plate, and further includes a λ/2 plate or a compensation film.

The phase difference film will be described in further detail with reference to FIG. 12 below.

The alignment layers 11 and 21 are rubbed at a predetermined angle φ of about from 0 degrees to 50 degrees with respect to the pixel electrodes 191 and 191-1 and the common electrode 123 that are parallel to each other.

A liquid crystal layer 3 including a plurality of biaxial liquid crystal molecules 310 is formed between the thin film transistor array panel 100 and the counter display panel 200.

In the above second exemplary embodiment, a phase difference value of the reflective region RA is adjusted to be half of the phase difference value of the transmissive region TA by controlling a refractive index value for the phase difference values.

That is to say, the pixel electrodes 191 and 191-1 receive different data voltages through the data lines 171 and 171-1 such that the biaxial liquid crystal molecules 310 are differently rotated in the reflective region and the transmissive region to form the phase difference value of the reflective region at half of the phase difference value of the transmissive region.

As a result, the phase difference values for the light to display the images through the reflective region RA become the same as the phase difference values for the light to display the images through the transmissive region TA.

When considering the light paths and the error according to the exemplary embodiment, the phase difference value of the reflective region is from more than 25% to less than 75% of the phase difference of the transmissive region TA.

In the above second exemplary embodiment, two thin film transistors are connected to one gate line, but it is possible for two thin film transistors to connect to different gate lines.

Here, two thin film transistors disposed in one pixel area are connected to different gate lines and different data lines.

Next, the third exemplary embodiment will be described.

In the third exemplary embodiment, two pixel electrodes are capacitively coupled to each other such that the arrangements of the liquid crystal molecules 310 in the reflective region RA and the transmissive region TA become different. Accordingly, the phase difference value of the reflective region RA becomes half of the phase difference value of the region TA in this exemplary embodiment.

For this purpose, two pixel electrodes 191 and 191-1 in one pixel area are capacitively coupled to each other through a connecting electrode 131.

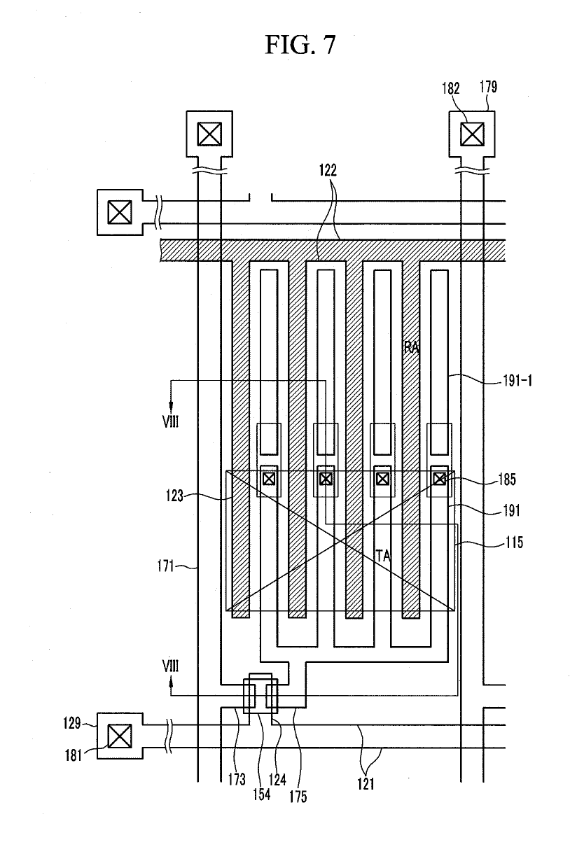

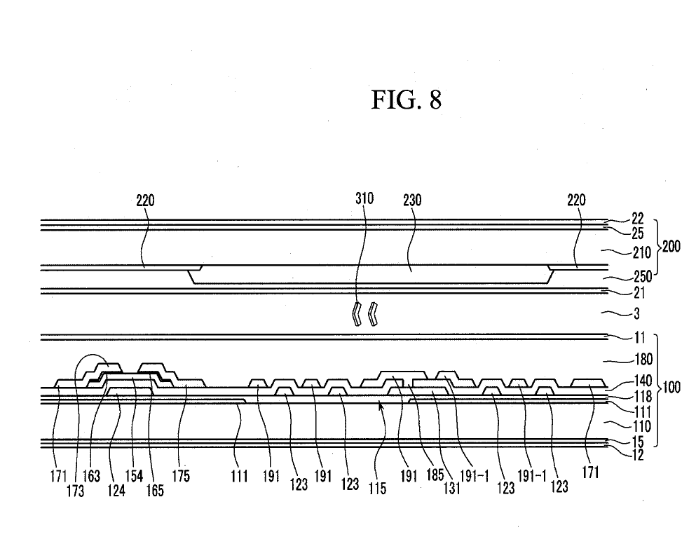

This will be described in detail with reference to FIG. 7 and FIG. 8.

FIG. 7 is a layout view of a liquid crystal display according to the third exemplary embodiment of the present invention, and FIG. 8 is a cross-sectional view of the liquid crystal display shown in FIG. 7 taken along the line VIII-VIII.

A liquid crystal display according to the third exemplary embodiment of the present invention includes a thin film transistor array panel 100 including a thin film transistor, a counter display panel 200, and a liquid crystal layer 3 formed therebetween.

Thin film transistor array panel 100 is described below.

A reflector 111 is formed an insulating substrate 110.

The reflector 111 includes a plurality of openings 115, and the openings 115 define a plurality of regions TA in pixel areas, where the light incident from the lower side is transmitted to display images.

The reflector 111 occupies the whole display area of the insulating substrate 110 except for the openings 115.

The regions occupied by the reflector 111 in the pixel area are reflective regions RA where the light incident from the upper side is reflected to display the images.

An insulating layer 118 is formed on the reflector 111 and the insulating substrate 110.

The insulating layer 118 is preferably made of an organic material or an organic insulating material.

A plurality of gate lines 121, a plurality of connecting electrodes 131, and a plurality of common electrode lines 122 are formed on the insulating layer 118.

The gate lines 121 transmit gate signals, and extend in the horizontal direction.

Each gate line 121 includes a plurality of gate electrodes 124 protruding upward and an end portion 129 having a large area for connection with another layer or an external driving circuit.

The connecting electrodes 131 are used for capacitively connecting two pixel electrodes 191 and 191-1 in the pixel area.

The common electrode lines 122 extend substantially in a transverse direction and parallel to the gate lines, and are supplied with a predetermined voltage.

Each common electrode line 122 includes a plurality of common electrodes 123 that are extended in the vertical direction in the pixel area.

A gate insulating layer 140 is formed on the whole surface of the substrate including the gate lines 121, the connecting electrodes 131, and the common electrode lines 122, and the gate insulating layer 140 has a plurality of contact holes 185 exposing portions of the connecting electrodes 131.

A plurality of semiconductors 154 preferably made of amorphous silicon or polysilicon are formed on the insulating layer 140.

The semiconductors 154 are disposed on the gate electrodes 124.

A plurality of pairs of ohmic contacts 163 and 165 preferably made of a material such as n+ hydrogenated amorphous silicon are formed on the semiconductors 154.

A plurality of data lines 171 and a plurality of pixel electrodes 191 and 191-1 are formed on the ohmic contacts 163 and 165 and the gate insulating layer 140.

The data lines 171 for transmitting data signals extend substantially in a vertical direction, thereby crossing the gate lines 121 and the common electrode lines 122.

Each of data lines 171 include a plurality of source electrodes 173 extending toward the gate electrodes 124, and an end portion 179 having a large area for connection with another layer or an external driving circuit.

The drain electrodes 175 opposite to the source electrodes 173 with respect to the gate electrodes 124 are extended and connected to the first pixel electrodes 191.

The pixel electrodes 191 are disposed in a pixel defined by the gate lines 121 and the data lines 171, and include a plurality of comb portions disposed between the neighboring common electrodes 123 and a connection portion connecting the comb portions.

The first pixel electrodes 191 are electrically connected to the connecting electrodes 131 through the contact holes 185.

On the other hand, the second pixel electrodes 191-1 extend according to the extended lines of the first pixel electrodes 191 and are separated from the first pixel electrodes 191.

The first pixel electrodes 191 are capacitively coupled to the second pixel electrodes 191-1 through the connecting electrodes 131.

That is to say, the data voltage applied to the first pixel electrodes 191 is applied to the connecting electrodes 131, and the connecting electrodes 131 are capacitively coupled to the second pixel electrodes 191-1 via the gate insulating layer 140.

As a result, if the voltage applied to the first pixel electrode 191 is changed, the voltage applied to the second pixel electrode 191-1 is changed.

Here, the first pixel electrodes 191 directly receive the data voltages from the drain electrodes, and the first pixel electrodes 191 have higher voltages than those of the second pixel electrodes 191-1.

The first pixel electrodes 191 are disposed in the transmissive region TA, and the second pixel electrodes 191-1 are disposed in the reflective region RA.

The comb portions of the first and second pixel electrodes 191 and 191-1 are disposed parallel to the common electrode 123 such that a horizontal electric field is formed.

A gate electrode 124, a source electrode 173, and a drain electrode 175 along with the semiconductor 154 form a thin film transistor having a channel formed in the semiconductor 154 disposed between the source electrode 173 and the drain electrode 175.

A passivation layer 180 is formed on the data lines 171 and the pixel electrodes 191 and 191-1.

The passivation layer 180 has a plurality of contact holes 182 exposing the end portions 179 of the data lines 171, and the passivation layer 180 and the gate insulating layer 140 have a plurality of contact holes 181 exposing the end portions of the gate lines 121.

A lower alignment layer 11 is formed on the passivation layer 180.

On the other hand, a lower polarizer 12 is attached to the lower surface of the insulating substrate 110.

Also, a lower phase difference film 15 may be provided on the inside or outside of the insulating substrate 110, and the lower phase difference film 15 attached to the outside is shown in FIG. 3.

The lower phase difference film 15 include a λ/4 plate, and further included a λ/2 plate or a compensation film.

The phase difference film will be described in further detail with reference to FIG. 12 below.

Next, the counter display panel 200 facing the thin film transistor array panel 100 is described.

A blocking member 220 called a black matrix is formed on an insulating substrate 210, and a plurality of color filters 230 are also formed thereon. The color filters 230 are disposed substantially in the areas enclosed by the light blocking member 220.

The color filters 230 cover the pixel areas.

On the other hand, the color filters 230 may have a thickness difference between the transmissive region TA and the reflective region RA.

That is to say, when displaying the images, the light transmits through the color filters 230 once in the transmissive region TA, but the light transmits through the color filters 230 twice in the reflective region RA such that the color filters 230 disposed on the transmissive region TA may have the thicker thickness than the color filters 230 disposed on the reflective region RA to remove the impression of color differences.

An overcoat 250 formed on the color filters 230 is preferably made of an organic material.

An upper alignment layer 21 is formed on the overcoat 250, and an upper polarizer 22 is attached to the outer surface of the insulating substrate 210.

Also, an upper phase difference film 25 may be provided on the inside or outside of the insulating substrate 210, and the phase difference film 25 attached to the outside is shown in FIG. 3.

The upper phase difference film 25 include a λ/4 plate, and further includes a λ/2 plate or a compensation film.

The phase difference film will be described in further detail with reference to FIG. 12 below.

The alignment layers 11 and 21 are rubbed at a predetermined angle φ of about from 0 degrees to 50 degrees with respect to the pixel electrodes 191 and the common electrodes 123 that are parallel to each other.

A liquid crystal layer 3 including a plurality of biaxial liquid crystal molecules 310 is formed between the thin film transistor array panel 100 and the counter display panel 200.

In the above third exemplary embodiment, a phase difference value of the reflective region becomes half of the phase difference value of the transmissive region by controlling a refractive index value for the phase difference values.

Here, the second pixel electrodes 191-1 and the first pixel electrodes 191 are capacitively coupled and receive the data voltages to apply the different voltages to each of the first and second pixel electrodes 191 and 191-1.

The voltage applied to the second pixel electrode 191-1 is controlled by controlling the capacitive coupling capacitance such that the phase difference value of the reflective region may be half of the phase difference value of the transmissive region.

As a result, the phase difference values experienced by the light for displaying the images through the reflective region RA and the transmissive region TA become the same.

Considering the light path and the error according to the exemplary embodiment, it is preferable that the phase difference value in the reflective region is in a range of about from 25% to 75% of the phase difference of the transmissive region.

Next, a liquid crystal display according to the fourth exemplary embodiment will be described in detail.

The fourth exemplary embodiment includes a pixel electrode 191 of a reflective region and a pixel electrode 191-1 of a transmissive region that are electrically connected to each other, but they are not both parallel with reference to the data line 171.

That is to say, the pixel electrode 191-1 disposed in the transmissive region TA is parallel to the data line 171, but the pixel electrode 191 disposed in the reflective region RA forms an angle θ with the data line 171.

Also, a common electrode 123-1 disposed in the transmissive region TA is parallel to the data line 171, but a common electrode 123 disposed in the reflective region RA is parallel to the pixel electrode 191 of the reflective region RA such that the common electrode 123 forms the angle θ with the data line 171.

Accordingly, although the voltages applied to the pixel electrodes 191 and 191-1 in the reflective region RA and the transmissive region TA are the same, the directions generated by the voltages are different from each other such that the arrangements of the liquid crystal molecules 310 are different from each other in the reflective region RA and the transmissive region TA.

That is, the range of the rotation of the liquid crystal molecules 310 in the reflective region RA is decreased compared to that of the transmissive region TA.

The phase difference value of the reflective region RA becomes half of the phase difference value of the transmissive region TA by adjusting the range of the rotation of the liquid crystal molecules 310 in this exemplary embodiment.

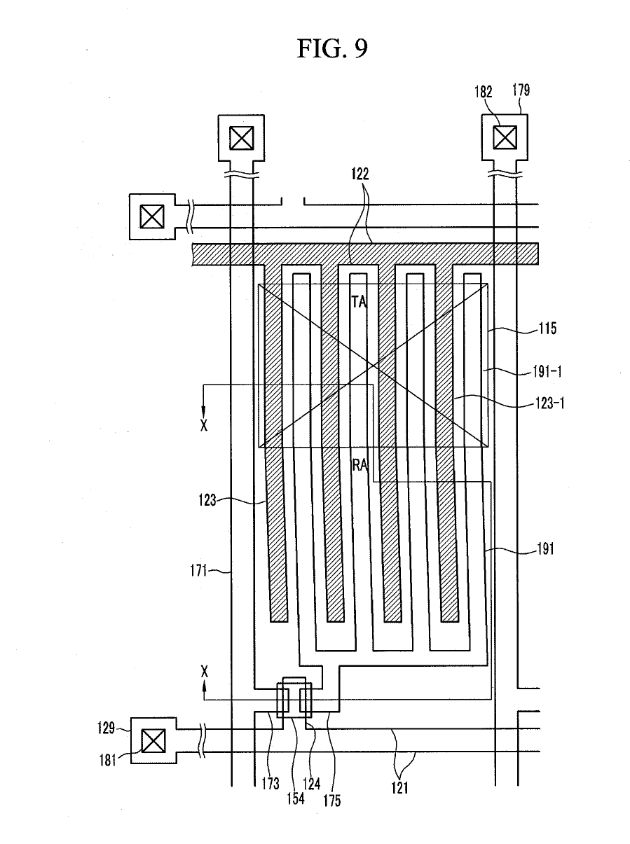

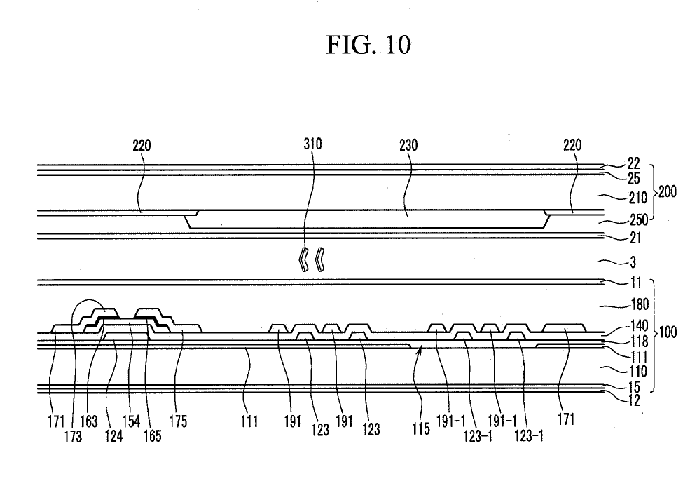

This embodiment will be described in detail with reference to FIG. 9 and FIG. 10.

FIG. 9 is a layout view of a liquid crystal display according to the fourth exemplary embodiment of the present invention, and FIG. 10 is a cross-sectional view of the liquid crystal display shown in FIG. 9 taken alone the line X-X.

A liquid crystal display according to the fourth exemplary embodiment of the present invention includes a thin film transistor array panel 100 including a thin film transistor, a counter display panel 200, and a liquid crystal layer 3 formed therebetween.

Firstly, the thin film transistor array panel 100 will be described.

A reflector 111 is formed an insulating substrate 110.

The reflector 111 includes a plurality of openings 115, and the openings 115 define a plurality of regions TA in pixel areas, where the light incident from the lower side is transmitted to display images.

The reflector 111 occupies the whole display area of the insulating substrate 110 except for the openings 115.

The regions occupied by the reflector 111 in the pixel area are reflective regions RA where the light incident from the upper side is reflected to display the images.

An insulating layer 118 is formed on the reflector 111 and the insulating substrate 110.

The insulating layer 118 is preferably made of an organic material or an organic insulating material.

A plurality of gate lines 121 and a plurality of common electrode lines 122 are formed on the insulating layer 118.

The gate lines 121 transmit gate signals, and extend in the horizontal direction.

Each gate line 121 includes a plurality of gate electrodes 124 and 124-1 protruding upward and an end portion 129 having a large area for connection with another layer or an external driving circuit.

The common electrode lines 122 extend substantially in a transverse direction and parallel to the gate lines, and are supplied with a predetermined voltage.

Each common electrode line 122 includes a plurality of common electrodes 123 and 123-1 that are extended in the vertical direction in the pixel area.

The common electrodes 123 and 123-1 include the common electrode portions 123 disposed in the reflective region RA and the common electrode portions 123-1 disposed in the transmissive region TA and forming a predetermined angle θ with the common electrode portions 123.

A gate insulating layer 140 is formed on the whole surface of the substrate including the gate lines 121 and the common electrode lines 122, and a plurality of semiconductors 154 preferably made of amorphous silicon or polysilicon are formed on the insulating layer 140.

The semiconductors 154 are respectively disposed on the gate electrodes 124.

A plurality of pairs of ohmic contacts 163 and 165 preferably made of a material such as n+ hydrogenated amorphous silicon are formed on the semiconductors 154.

A plurality of data lines 171 and a plurality of pixel electrodes 191 and 191-1 are formed on the ohmic contacts 163 and 165 and the gate insulating layer 140.

The data lines 171 for transmitting data signals substantially extend in a vertical direction, thereby crossing the gate lines 121 and the common electrode lines 122.

Each of data lines 171 include a plurality of source electrodes 173 extending toward the gate electrodes 124, and end portions 179 having a large area for connection with another layer or an external driving circuit.

The drain electrodes opposite the source electrodes 173 with respect to the gate electrodes 124 are respectively extended and connected to the pixel electrodes 191 and 191-1.

The pixel electrodes 191 and 191-1 include portions of the pixel electrode 191 disposed in the reflective region and portions of the pixel electrode 191-1 disposed in the transmissive region.

The pixel electrodes 191 and 191-1 are disposed in pixels defined by the gate lines 121 and the data lines 171, and the portions of the pixel electrode 191-1 disposed in the transmissive region are parallel to the data lines 171.

On the other hand, the portions of the pixel electrode 191 of the reflective region form a predetermined angle θ with the data lines 171.

The pixel electrodes 191 and 191-1 respectively include a plurality of comb portions disposed between the neighboring common electrodes 123 and 123-1 and a connection portion for connecting the comb portions.

The portions of the pixel electrode 191 and portions of the common electrode 123 are parallel to each other in the reflective region, and the portions of the pixel electrode 191-1 and portions of the common electrode 123-1 are parallel to each other in the transmissive region.

That is say, the portions of the pixel electrode 191 and the portions of the common electrode 123 are arranged at a predetermined angle θ with respect to the data lines 171 in the reflective region, and the portions of the pixel electrode 191-1 and the portions of the common electrode 123-1 are arranged parallel to the data lines 171 in the transmissive region.

A gate electrode 124, a source electrode 173, and a drain electrode 175 along with a semiconductor 154 form one thin film transistor having a channel formed in the semiconductor 154 disposed between the source electrode 173 and the drain electrode 175.

A passivation layer 180 is formed on the data lines 171 and the pixel electrodes 191 and 191-1.

The passivation layer 180 has a plurality of contact holes 182 exposing the end portions 179 of the data lines 171, and the passivation layer 180 and the gate insulating layer 140 have a plurality of contact holes 181 exposing the end portions of the gate lines 121.

A lower alignment layer 11 is formed on the passivation layer 180.

On the other hand, a lower polarizer 12 is attached to the lower surface of the insulating substrate 110.

Also, a lower phase difference film 15 may be provided on the inside or outside of the insulating substrate 110, and the lower phase difference film 15 attached to the outside is shown in FIG. 3.

The lower phase difference film 15 include a λ/4 plate, and further includes a λ/2 plate or a compensation film.

The phase difference film will be described in further detail FIG. 12 below.

Next, the counter display panel 200 facing the thin film transistor array panel 100 will be described.

A blocking member 220 called a black matrix is formed on an insulating substrate 210, and a plurality of color filters 230 is also formed thereon. The color filters 230 are disposed substantially in the areas enclosed by the light blocking member 220.

The color filters 230 cover the pixel areas.

On the other hand, the color filters 230 may have a thickness difference between the transmissive region TA and the reflective region RA.

That is to say, when displaying the images, the light transmits through the color filters 230 once in the transmissive region TA, but the light transmits through the color filters 230 twice in the reflective region RA such that the color filters 230 disposed on the transmissive region TA may have a thicker thickness than the color filters 230 disposed on the reflective region RA to remove the impression of a color difference.

An overcoat 250 preferably made of an organic material is formed on the color filters 230.

An upper alignment layer 21 is formed on the overcoat 250, and an upper polarizer 22 is attached to the outer surface of the insulating substrate 210.

Also, an upper phase difference film 25 may be provided on the inside or outside of the insulating substrate 210, and the phase difference film 25 attached to the outside is shown in FIG. 3.

The upper phase difference film 25 include a λ/4 plate, and further includes a λ/2 plate or a compensation film.

The phase difference film will be described in further detail with reference to FIG. 12 below.

The alignment layers 11 and 21 are rubbed at a predetermined angle φ of about 0 degrees to 50 degrees with respect to the pixel electrodes 191 and the common electrode 123 that are parallel to each other.

A liquid crystal layer 3 including a plurality of biaxial liquid crystal molecules 310 is formed between the thin film transistor array panel 100 and the counter display panel 200.

In the above fourth exemplary embodiment, a phase difference value of a reflective region is adjusted to be half of the phase difference value of the transmissive region by controlling the direction of the electric field with respect to the rubbing direction.

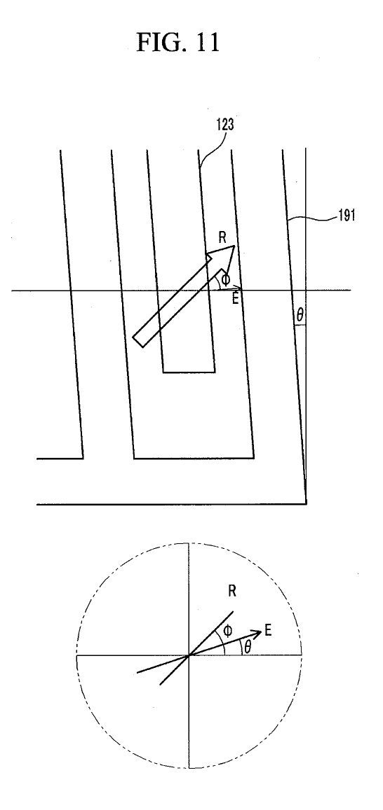

This is shown in detail in FIG. 11.

FIG. 11 is a view showing a direction E of the electric field and a rubbing direction R of the reflective region RA in the fourth exemplary embodiment.

The vertical line is parallel to the data line 171, and the horizontal line is parallel to the gate line 121.

When applying the same voltages in the transmissive region TA and the reflective region RA, the direction E of the electric field of the voltage applied to the liquid crystal molecules 310 in the reflective region RA has a predetermined angle θ with respect to the data line 171.

As a result, the liquid crystal molecules 310 are differently arranged between the transmissive region TA and the reflective region RA under the application of the same voltage.

In particular, the rotation angle of the liquid crystal molecules 310 in the transmissive region TA is an angle φ formed between the horizontal line and the rubbing direction R, but the rotation angle of the liquid crystal molecules 310 in the reflective region RA is an angle φ-θ.

Referring to FIG. 11, as a result, a phase difference value of a reflective region is adjusted to be half of the phase difference value of the transmissive region, and the phase difference value experienced by the light to display the images becomes the same between the transmissive region TA and the reflective region RA.

When considering the light paths and the error according to the exemplary embodiment, the phase difference value of the reflective region is from more than 25% to less than 75% of the phase difference of the transmissive region TA.

In FIG. 2 to FIG. 11, the structure in which the phase difference value of the liquid crystal layer in the reflective region is half of the phase difference of the liquid crystal layer in the transmissive region has been described through different exemplary embodiments.

In the transflective display device as above-described, although the relation for the phase difference values of the liquid crystal layer between the reflective region and the transmissive region is satisfied, the images are not displayed identically.

That is, the phase of the light is changed 180 degrees by the reflection of the reflector 111 in the reflective region such that if the white is generally displayed in the transmissive region, the black is displayed in the reflective region, and as a result different colors are represented.

To solve this drawback, a λ/4 plate is needed to display the same luminance in the reflective region and the transmissive region.

In FIG. 12 to FIG. 19, a λ/4 plate 16 and a reflector 111 will be described to display the same luminance in the reflective region and the transmissive region through the various exemplary embodiments.

Firstly, FIG. 12 is the view showing the structure of a liquid crystal display according to the fifth exemplary embodiment of the present invention.

In FIG. 12, differently from FIG. 2 to FIG. 10, the constituent elements affecting the polarization component of the light are mainly shown, and the structure of each pixel is in accordance with one of the first to fourth exemplary embodiments.

An upper polarizer 22 and a lower polarizer 12 are attached to the outermost surfaces of the liquid crystal display, and respectively have a transmissive axis.

The transmissive axis of the upper polarizer 22 is indicated by A, and the transmissive axis of the lower polarizer 12 is indicated by A′.

As shown in FIG. 12, the transmissive axis A of the upper polarizer 22 is perpendicular to the transmissive axis A′ of the lower polarizer 12.

The liquid crystal layer 3 is a liquid crystal layer including biaxial liquid crystal molecules, and includes a reflective region RA and a transmissive region TA.

The liquid crystal layer 3 is aligned in a predetermined direction by rubbing an alignment layer (not shown), and the rubbing direction may be parallel to the transmissive axis of the upper polarizer 22 or the lower polarizer 12.

A reflector 111 and a λ/4 plate 16 are formed in the reflective region, and the reflector 111 and the λ/4 plate 16 are not present in the transmissive region.

The λ/4 plate 16 has a slow axis forming 45 degrees along with the transmissive axis of the polarizers 12 and 22.

In FIG. 12, the slow axis of the λ/4 plate 16 is indicated by B.

Also, the λ/4 plate 16 may be attached between the polarizers 12 and 22, and the substrates 110 and 210, however it is formed as an inner λ/4 plate inside of the substrates 110 and 210 in the fifth exemplary embodiment of the present invention.

That is, the λ/4 plate 16 is an upper portion of the lower substrate 110 and is formed on the reflector 111.

The inner λ/4 plate 16 is not a film type, and it aligns and hardens the liquid crystal in the predetermined direction to delay the phase of the light of the slow axis direction by λ/4 when the light is transmitted.

In the inner λ/4 plate 16, an alignment layer may be used to align the liquid crystal.

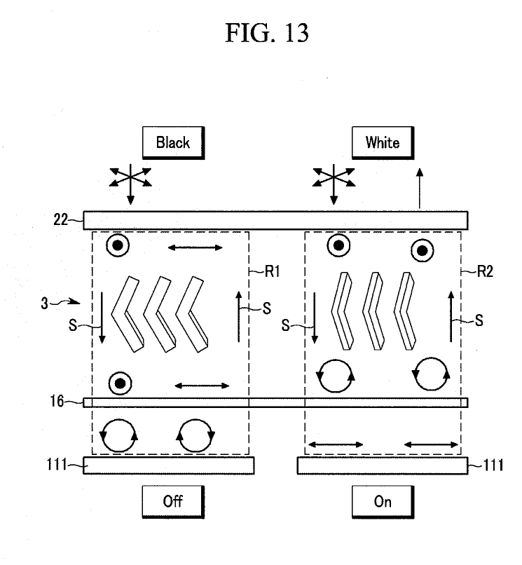

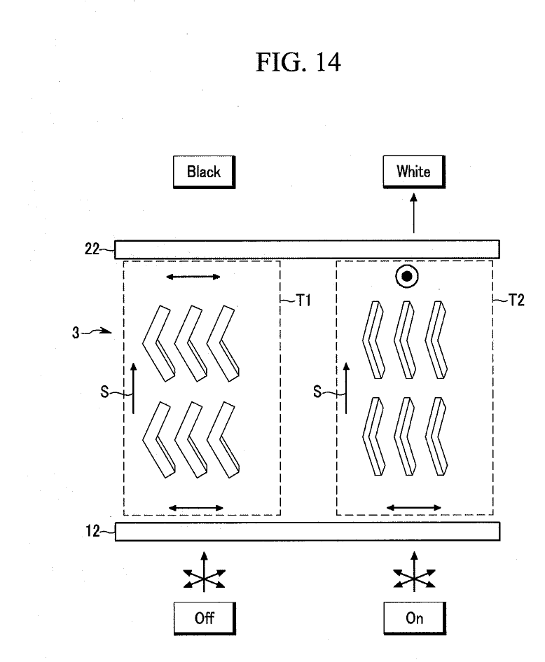

Next, the polarization state of the light when displaying the images in the liquid crystal display according to the fifth exemplary embodiment of the present invention will be described with reference to FIG. 13 and FIG. 14.

FIG. 13 and FIG. 14 are views showing the polarization state of the light when displaying images in the liquid crystal display shown in FIG. 12.

FIG. 13 shows the polarization state of the light in the reflective region, and FIG. 14 shows the polarization state of the light in the transmissive region.

Firstly, the polarization state of the light in the reflective region will be described.

In FIG. 13, an R1 region of the left side shows the polarization state when displaying the black in the reflection mode, and the R2 region of the right side shows the polarization state when displaying the white.

In FIG. 13, the progressing direction of the light is indicated by an arrow S.

Firstly, the display of the black will be described.

The light incident from the external is incident to the upper polarizer 22.

The light of the polarization component of the transmissive axis (⊙) direction of the upper polarizer 22 is transmitted and is progressed downward, and the light of the direction [symbol] perpendicular thereto is absorbed.

The transmitted light is passed through the liquid crystal layer 3.

When displaying the black, the liquid crystal layer 3 is formed not to affect the polarization component when the light is transmitted.

This is referred to as an off state hereinafter. As a result, although the light is passed through the liquid crystal layer 3, the polarization component is not changed.

Next, the light is passed through the λ/4 plate 16.

The slow axis of the λ/4 plate 16 forms 45 degrees along with the transmissive axis of the upper polarizer 22 such that the light is changed into counter-clockwise polarization.

The light is then reflected by the reflector 111 such that the polarization component is changed by 180 degrees into clockwise polarization.

The light is again passed through the λ/4 plate 16 such that the light is changed in the line polarization [symbol] perpendicular to the transmissive axis of the upper polarizer 22.

When the light is again passed through the liquid crystal layer 3, the polarization component of the light is not changed such that the line polarization [symbol] is maintained.

Next, if the light is incident to the upper polarizer 22, the line polarization [symbol] corresponds with the absorption axis of the upper polarizer 22 such that the light is completely absorbed and is not emitted to the external, thereby displaying the black.

Now, the display of the white will be described.

The light incident from the external is incident to the upper polarizer 22.

The light of the polarization component of the transmissive axis (⊙) direction of the upper polarizer 22 is transmitted and is progressed downward, and the light of the perpendicular direction [symbol] thereto is absorbed.

The transmitted light is passed through the liquid crystal layer 3.

When displaying the white, the liquid crystal layer 3 is formed to have the phase difference of λ/4.

This is referred to as an on state hereinafter. As a result, if the light is passed through the liquid crystal layer 3, the light is changed into counter-clockwise polarization.

Next, the light is passed through the λ/4 plate 16.

The slow axis of the λ/4 plate 16 forms 45 degrees along with the transmissive axis of the upper polarizer 22 such that the light is changed into line polarization [symbol] perpendicular to the transmissive axis of the upper polarizer 22.

Next, the light is reflected by the reflector 111 such that the polarization component is changed by 180 degrees, however, although the light polarization is changed by the phase difference of 180 degrees, it is the line polarization of the same direction such that the line polarization [symbol] perpendicular to the transmissive axis is maintained.

Next, the light is again passed through the λ/4 plate 16 such that the light is changed into counter-clockwise polarization.

If the light is passed through the liquid crystal layer 3, the light receives the phase difference of λ/4 such that the light is changed into the light ⊙ having the same direction as the transmissive axis of the upper polarizer 22.

If the light is incident to the upper polarizer 22, the light corresponds with the transmissive axis of the upper polarizer 22 such that the light is transmitted, thereby displaying the white.

The cases of the black and the white have explained above.

If the liquid crystal layer 3 is maintained in a state between the on state and the off state, a portion of the light is transmitted such that a gray may be displayed by controlling the transmittance of the light.

Next, the polarization component of the light in the transmissive region will be described with reference to FIG. 14.

In the liquid crystal layer 3 of the transmissive region, a phase difference of two times is provided compared with the reflection.

In FIG. 14, a T1 region of the left side shows the polarization state when displaying the black in the reflection mode, and a T2 region of the right side shows the polarization state when displaying the white.

In FIG. 14, the progressing direction of the light is also indicated by an arrow S.

Firstly, the display of the black will be described.

The light incident from a backlight (not shown) is incident to the lower polarizer 12.

The light of the polarization component of the transmissive axis [symbol] direction of the lower polarizer 12 is transmitted and is progressed upward, and the light of the direction ⊙ perpendicular thereto is absorbed.

The reflector 111 and the λ/4 plate 16 do not exist in the transmissive region such that the transmitted light is directly incident to the liquid crystal layer 3.

Here, the liquid crystal layer 3 is the off state to display the black like the display of the black in the reflective region such that the liquid crystal layer 3 does not affect the polarization component when the light is transmitted.

As a result, although the light is passed through the liquid crystal layer 3, the polarization component of the light is not changed.

Next, if the light is incident to the upper polarizer 22, it corresponds to the absorption axis of the upper polarizer 22 such that the light is absorbed and is not emitted, and as a result the black is displayed.

The display of the white will now be described.

The light incident from a backlight (not shown) is incident to the lower polarizer 12.

The light of the polarization component of the transmissive axis [symbol] direction of the lower polarizer 12 is transmitted and is progressed upward, and the light of the direction ⊙ perpendicular thereto is absorbed.

The reflector 111 and the λ/4 plate 16 do not exist In the transmissive region such that the transmitted light is directly incident to the liquid crystal layer 3.

The liquid crystal layer 3 is in the on state to display the white like the display of the white in the reflective region such that the liquid crystal layer 3 affects the polarization component when the light is transmitted.

Here, the phase difference with λ/4 is provided in the liquid crystal layer 3 of the reflective region, however a phase difference of two times, that is, a phase difference of λ/2, is provided in the transmissive region.

As a result, the light is rotated by 90 degrees such that the light is changed into the light of the direction ⊙ that is perpendicular to the transmissive axis of the lower polarizer 12.

Next, if the light is incident to the upper polarizer 22, it corresponds to the transmissive axis of the upper polarizer 22 such that the light is completely transmitted, thereby displaying the white.

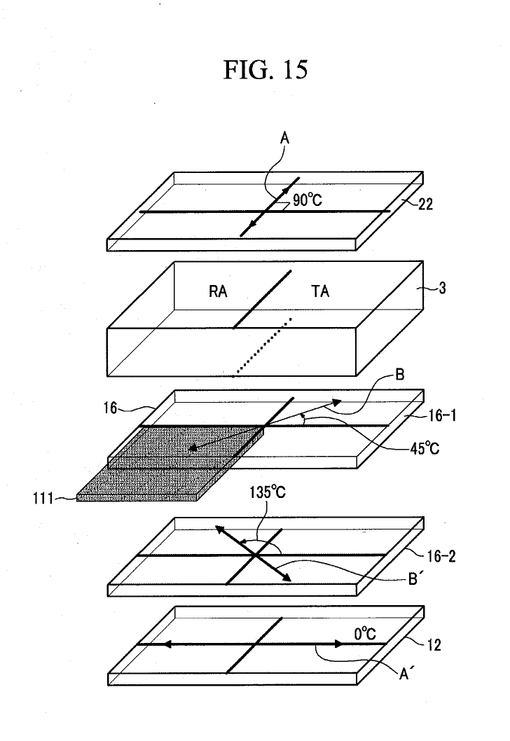

FIG. 15 is a view showing a structure of a liquid crystal display according to the sixth exemplary embodiment of the present invention.

In FIG. 15, like FIG. 12, the constituent elements affecting the polarization component of the light are mainly shown, and the structure of each pixel is in accordance with one of the first to fourth exemplary embodiments.

An upper polarizer 22 and a lower polarizer 12 are attached to the outermost surfaces of the liquid crystal display, and respectively have a transmissive axis.

The transmissive axis of the upper polarizer 22 is indicated by A, and the transmissive axis of the lower polarizer 12 is indicated by A′.

As shown in FIG. 15, the transmissive axis A of the upper polarizer 22 is perpendicular to the transmissive axis A′ of the lower polarizer 12.

The liquid crystal layer 3 is a liquid crystal layer including biaxial liquid crystal molecules, and includes a reflective region RA and a transmissive region TA.

The liquid crystal layer 3 is aligned in a predetermined direction by rubbing an alignment layer (not shown), and the rubbing direction may be parallel to the transmissive axis of the upper polarizer 22 or the lower polarizer 12.

An upper λ/4 plate 16-1 and a lower λ/4 plate 16-2 are formed on the reflective region and the transmissive region, and a reflector 111 is formed on the reflective region.

The reflector 111 does not exist in the transmissive region.

The upper and lower λ/4 plates 16-1 and 16-2 have slow axes forming 45 degrees with the transmissive axes of the polarizers 12 and 22, and the slow axis of the upper λ/4 plate 16-1 forms 90 degrees with the slow axis of the lower λ/4 plate 16-2.

In FIG. 15, the slow axis of the upper λ/4 plate 16-1 is indicated by B, and the slow axis of the lower λ/4 plate 16-2 is indicated by B′.

Also, the upper and lower λ/4 plates 16-1 and 16-2 may be attached between the polarizers 12 and 22, and the substrates 110 and 210.

In the sixth exemplary embodiment of the present invention, the upper λ/4 plate 16-1 is formed as an inner λ/4 plate inside the substrates 110 and 210, and the lower λ/4 plate 16-2 is formed between the lower substrate 110 and the lower polarizer 12.

That is, the upper λ/4 plate 16-1 is an upper portion of the lower substrate 110, the λ/4 plate 16 is formed on the reflector 111, and the lower λ/4 plate 16-2 is attached between the lower polarizer 12 and the substrate 110 as a film type.

The upper λ/4 plate 16-1 formed in the inner portion is not a film type, and aligns and hardens the liquid crystal in the predetermined direction to delay the phase of the light of the slow axis direction by λ/4 when the light is transmitted.

In the upper λ/4 plate 16-1, an alignment layer may be used to align the liquid crystal.

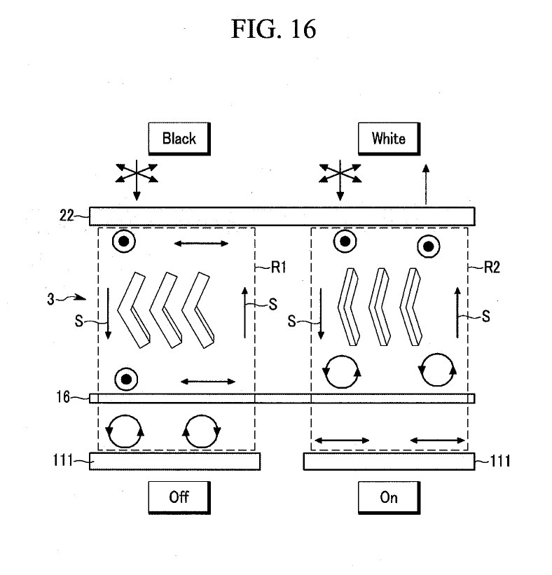

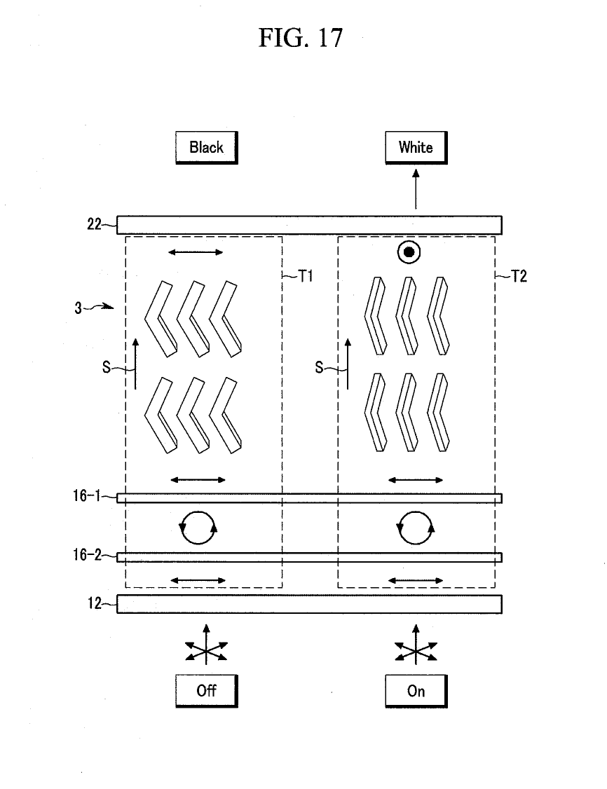

Next, the polarization state of the light when displaying the images in the liquid crystal display according to the fifth exemplary embodiment of the present invention will be described with FIG. 16 and FIG. 17.

FIG. 16 and FIG. 17 are views showing the polarization state of the light when displaying images in the liquid crystal display shown in FIG. 15.

FIG. 16 shows the polarization state of the light in the reflective region, and FIG. 17 shows the polarization state of the light in the transmissive region.

Firstly, the polarization state of the light in the reflective region will be described.

In FIG. 16, an R1 region of the left side shows the polarization state when displaying the black in the reflection mode, and the R2 region of the right side shows the polarization state when display the white.

In FIG. 16, the progressing direction of the light is indicated by an arrow S.

Firstly, the display of the black will be described.

The light incident from the external is incident to the upper polarizer 22.

The light of the polarization component of the transmissive axis (⊙) direction of the upper polarizer 22 is transmitted and is progressed downward, and the light of the direction [symbol] perpendicular thereto is absorbed.

The transmitted light is passed through the liquid crystal layer 3.

When displaying the black, the liquid crystal layer 3 is formed to not affect the polarization component when the light is transmitted.

This is referred to as an off state hereinafter. As a result, although the light is passed through the liquid crystal layer 3, the polarization component is not changed.

Next, the light is passed through the λ/4 plate 16.

The slow axis of the λ/4 plate 16 forms 45 degrees with the transmissive axis of the upper polarizer 22 such that the light is changed into counter-clockwise polarization.

The light is then reflected by the reflector 111 such that the polarization component is changed by 180 degrees into clockwise polarization.

The light is again passed through the λ/4 plate 16 such that the light is changed in the line polarization [symbol] perpendicular to the transmissive axis of the upper polarizer 22.

When the light is again passed through the liquid crystal layer 3, the polarization component of the light is not changed such that the line polarization [symbol] is maintained.

Next, if the light is incident to the upper polarizer 22, the line polarization [symbol] corresponds with the absorption axis of the upper polarizer 22 such that the light is completely absorbed and is not emitted to the external, thereby displaying the black.

The display of the white will now be described.

The light incident from the external is incident to the upper polarizer 22.

The light of the polarization component of the transmissive axis (⊙) direction of the upper polarizer 22 is transmitted and is progressed downward, and the light of the perpendicular direction [symbol] thereto is absorbed.

The transmitted light is passed through the liquid crystal layer 3.

When displaying the white, the liquid crystal layer 3 is formed to have a phase difference of λ/4.

This is referred to as an on state hereinafter. As a result, if the light is passed through the liquid crystal layer 3, the light is changed into counter-clockwise polarization.

The light is then passed through the λ/4 plate 16.

The slow axis of the λ/4 plate 16 forms 45 degrees with the transmissive axis of the upper polarizer 22 such that the light is changed into a line polarization [symbol] perpendicular to the transmissive axis of the upper polarizer 22.

Next, the light is reflected by the reflector 111 such that the polarization component is changed by 180 degrees, however, although the light polarization is changed by the phase difference of 180 degrees, it is the line polarization of the same direction such that the line polarization [symbol] perpendicular to the transmissive axis is maintained.

The light is again passed through the λ/4 plate 16 such that the light is changed into the counter-clockwise polarization.

If the light is passed through the liquid crystal layer 3, the light receives the phase difference of λ/4 such that the light is changed into the light ⊙ having the same direction as the transmissive axis of the upper polarizer 22.

If the light is incident to the upper polarizer 22, the light corresponds to the transmissive axis of the upper polarizer 22 such that the light is transmitted, thereby displaying the white.

The cases of the black and the white have been explained above.

If the liquid crystal layer 3 is maintained with a state between the on state and the off state, a portion of the light is transmitted such that a gray may be displayed by controlling the transmittance of the light.

Next, the polarization component of the light in the transmissive region will be described with reference to FIG. 17.

In the liquid crystal layer 3 of the transmissive region, a phase difference of two times is provided compared with the reflection.

In FIG. 17, a T1 region of the left side shows the polarization state when displaying the black in the reflection mode, and the T2 region of the right side shows the polarization state when displaying the white.

In FIG. 17, the progressing direction of the light is also indicated by an arrow S.

Firstly, the display of the black will be described.

The light incident from a backlight (not shown) is incident to the lower polarizer 12.

The light of the polarization component of the transmissive axis [symbol] direction of the lower polarizer 12 is transmitted and is progressed upward, and the light of the direction ⊙ perpendicular thereto is absorbed.

The transmitted light is passed through the upper and lower λ/4 plates 16-1 and 16-2.

Firstly, if the light is passed through the lower λ/4 plate 16-2, it is changed into counter-clockwise polarization, and the light is changed into the light of the transmissive axis [symbol] direction of the lower polarizer 12 while passing through the upper λ/4 plate 16-1.

Next, the light is incident to the liquid crystal layer 3, and the liquid crystal layer 3 is the off state to display the black like the display of the black in the reflective region such that the liquid crystal layer 3 does not affect the polarization component when the light is transmitted.

As a result, although the light is passed through the liquid crystal layer 3, the polarization component of the light is not changed.

If the light is incident to the upper polarizer 22, it corresponds to the absorption axis of the upper polarizer 22 such that the light is absorbed and is not emitted, and as a result the black is displayed.

The display of the white will now be described.

The light incident from a backlight (not shown) is incident to the lower polarizer 12.

The light of the polarization component of the transmissive axis [symbol] direction of the lower polarizer 12 is transmitted and is progressed upward, and the light of the direction ⊙ perpendicular thereto is absorbed.

The transmitted light is transmitted to the upper and lower λ/4 plates 16-1 and 16-2.

Firstly, the light is changed into the counter-clockwise polarization while passing through the lower λ/4 plate 16-2, and is changed into the light of the transmissive axis ( [symbol] ) direction of the lower polarizer 12 while passing through the upper λ/4 plate 16-1.

Next, the light is incident to the liquid crystal layer 3, and the liquid crystal layer 3 is the on state to display the white like the display of the white in the reflective region such that the liquid crystal layer 3 affects the polarization component when the light is transmitted.

Here, the phase difference with λ/4 is provided in the liquid crystal layer 3 of the reflective region, however the phase difference of two times, that is, the phase difference of λ/2 is provided in the transmissive region.

As a result, the light is rotated by 90 degrees such that the light is changed into the light of the direction ⊙ perpendicular to the transmissive axis of the lower polarizer 12.

Next, if the light is incident to the upper polarizer 22, it corresponds to the transmissive axis of the upper polarizer 22 such that the light is completely transmitted, and as a result displays the white.

As shown in FIG. 17, the light having passed through the upper and lower λ/4 plates 16-1 and 16-2 has the same polarization direction as the incident light.

As a result, the polarization direction of FIG. 17 is not greatly different from the polarization direction of FIG. 14.

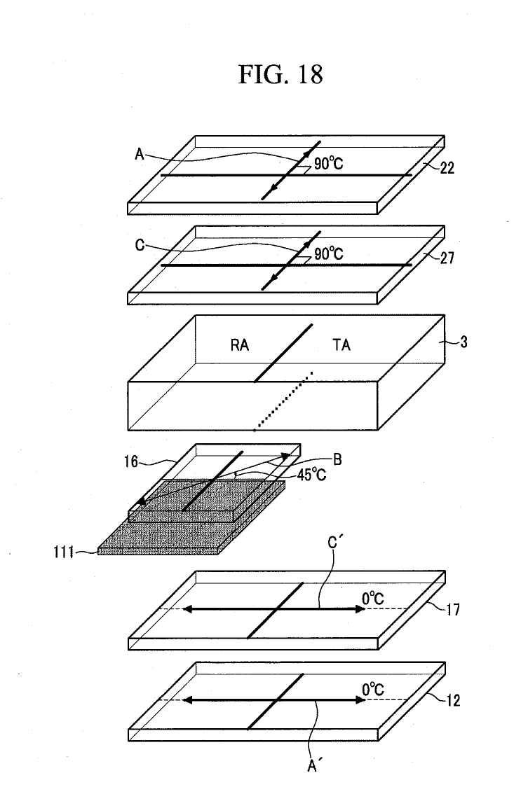

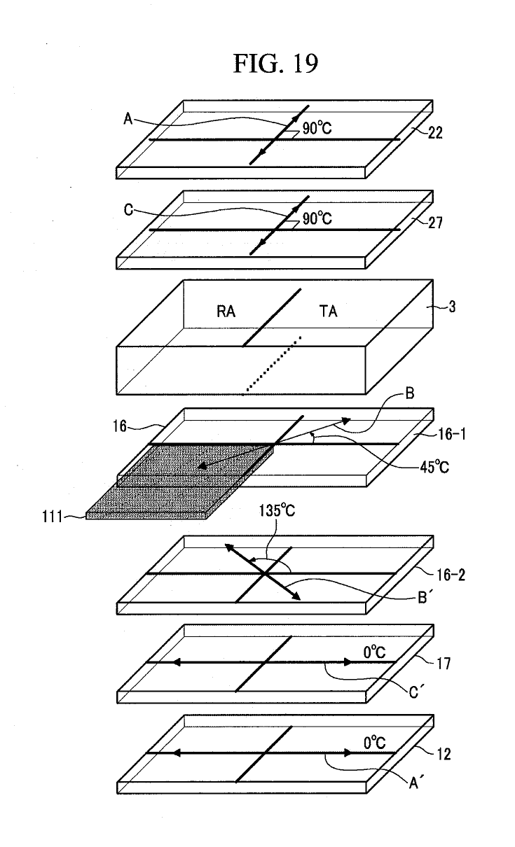

In FIG. 18 and FIG. 19, a liquid crystal display according to the seventh exemplary embodiment using a compensation film is shown.

FIG. 18 is a view showing a structure of a liquid crystal display according to the seventh exemplary embodiment of the present invention.

In FIG. 18, like FIG. 12, the constituent elements affecting the polarization component of the light are mainly shown, and the structure of each pixel is in accordance with one of the first to fourth exemplary embodiments.

An upper polarizer 22 and a lower polarizer 12 are attached to the outermost surfaces of the liquid crystal display, and respectively have a transmissive axis.

The transmissive axis of the upper polarizer 22 is indicated by A, and the transmissive axis of the lower polarizer 12 is indicated by A′.

Like FIG. 12, the transmissive axis A of the upper polarizer 22 is perpendicular to the transmissive axis A′ of the lower polarizer 12.

The liquid crystal layer 3 is a liquid crystal layer including biaxial liquid crystal molecules, and includes a reflective region RA and a transmissive region TA.

The liquid crystal layer 3 is aligned in a predetermined direction by rubbing an alignment layer (not shown), and the rubbing direction may be parallel to the transmissive axis of the upper polarizer 22 or the lower polarizer 12.

A reflector 111 and a λ/4 plate 16 are formed in the reflective region, and the reflector 111 and the λ/4 plate 16 are not present in the transmissive region.

The λ/4 plate 16 has a slow axis forming 45 degree along with the transmissive axis of the polarizers 12 and 22.

In FIG. 18, the slow axis of the λ/4 plate 16 is indicated by B.

Also, the λ/4 plate 16 may be attached between the polarizers 12 and 22, and the substrates 110 and 210, however it is formed as an inner λ/4 plate disposed inside of the substrates 110 and 210 in the seventh exemplary embodiment of the present invention.

That is, the λ/4 plate 16 is above the lower substrate 110 and is formed on the reflector 111.

The inner λ/4 plate 16 is not a film type, and aligns and hardens the liquid crystal in the predetermined direction to delay the phase of the light of the slow axis direction by λ/4 when the light is transmitted.

In the inner λ/4 plate 16, an alignment layer may be used to align the liquid crystal.

On the other hand, in the seventh exemplary embodiment of the present invention, an upper compensation film 27 and a lower compensation film 17 are respectively attached between the upper polarizer 22 and the upper substrate 210, and the lower polarizer 12 and the lower substrate 110.

Among the compensation films 17 and 27, only the upper compensation film 27 may be formed, or only the lower compensation film 17 may be formed.

The slow axes of the compensation films 17 and 27 are parallel to the transmissive axes of the polarizers 12 and 22 contacted thereto.

Also, when the refractive index of the biaxial liquid crystal molecules has the relation of nx, ny <nz, the compensation films 17 and 27 have the relation of the refractive index of nx, ny >nz, and nx and ny may be the same or different.

Here, nx, ny, and nz respectively mean a refractive index of an x axis direction, a refractive index of a y axis direction, and a refractive index of a z axis direction, wherein the x and y axis directions are parallel to the surface of the substrate and the z axis direction is perpendicular to the surface of the substrate.

The compensation films 17 and 27 that may be used in the exemplary embodiment of the present invention are compensation films used in the vertical alignment liquid crystal display.

This is because the liquid crystal has the biaxial characteristic, however the transmission characteristic of the biaxial liquid crystal is identically changed when viewing laterally compared with the front.

The characteristics of the compensation films 17 and 27 may be diverse according to the characteristics of each liquid crystal panel, and they compensate to wholly cause a uniform refractive index for each direction of the x axis, the y axis, and the z axis.

FIG. 19 is a view of a structure of a liquid crystal display according to the eighth exemplary embodiment of the present invention.

In FIG. 19, like FIG. 12, the constituent elements affecting the polarization component of the light are mainly shown, and the structure of each pixel is in accordance with one of the first to fourth exemplary embodiments.

An upper polarizer 22 and a lower polarizer 12 are attached to the outermost surfaces of the liquid crystal display, and respectively have a transmissive axis.

The transmissive axis of the upper polarizer 22 is indicated by A, and the transmissive axis of the lower polarizer 12 is indicated by A′.

Like FIG. 12, the transmissive axis A of the upper polarizer 22 is perpendicular to the transmissive axis A′ of the lower polarizer 12.

The liquid crystal layer 3 is a liquid crystal layer including biaxial liquid crystal molecules, and includes a reflective region RA and a transmissive region TA.

The liquid crystal layer 3 is aligned in a predetermined direction by rubbing an alignment layer (not shown), and the rubbing direction may be parallel to the transmissive axis of the upper polarizer 22 or the lower polarizer 12.

An upper λ/4 plate 16-1 and a lower λ/4 plate 16-2 are formed on the reflective region and the transmissive region, and the reflector 111 is formed on the reflective region.

The reflector 111 is not formed on the transmissive region.

The upper and lower λ/4 plates 16-1 and 16-2λ/4 has slow axes forming 45 degrees indicated with the transmissive axis of the polarizers 12 and 22, and the slow axis of the upper λ/4 plate 16-1 forms 90 degrees with the slow axis of the lower λ/4 plate 16-2.

In FIG. 19, the slow axis of the upper λ/4 plate 16-1 is indicated by B, and the slow axis of the lower λ/4 plate 16-2 is indicated by B′.

Also, the upper and lower λ/4 plates 16-1 and 16-2 may be attached between the polarizer 12 and 22, and the substrate 110 and 210.

In the sixth exemplary embodiment of the present invention, the upper λ/4 plate 16-1 is formed as an inner λ/4 plate disposed inside the substrates 110 and 210, and the lower λ/4 plate 16-2 is formed between the lower substrate 110 and the lower polarizer 12.

That is, the upper λ/4 plate 16-1 is an upper portion of the lower substrate 110, the λ/4 plate 16 is formed on the reflector 111, and the lower λ/4 plate 16-2 is attached between the lower polarizer 12 and the substrate 110 as a film type.

The upper λ/4 plate 16-1 formed in the inner portion is not a film type, and aligns and hardens the liquid crystal in the predetermined direction to delay the phase of the light of the slow axis direction by λ/4 when the light is transmitted.

In the upper λ/4 plate 16-1, an alignment layer may be used to align the liquid crystal.

On the other hand, in the eighth exemplary embodiment of the present invention, an upper compensation film 27 and a lower compensation film 17 are respectively attached between the upper polarizer 22 and the upper substrate 210, and the lower polarizer 12 and the lower λ/4 plate 16-2.

Among the compensation films 17 and 27, only the upper compensation film 27 may be formed, or only the lower compensation film 17 may be formed.

The slow axis of the compensation films 17 and 27 is parallel to the transmissive axis of the polarizers 12 and 22 contacted thereto.

Also, when the refractive index of the biaxial liquid crystal molecules has the relation of nx, ny <nz, the compensation films 17 and 27 have the relation of the refractive index of nx, ny >nz, and nx and ny may be the same or different.

Here, nx, ny, and nz respectively mean a refractive index of an x axis direction, a refractive index of a y axis direction, and a refractive index of a z axis direction, wherein the x and y axis directions are parallel to the surface of the substrate and the z axis direction is perpendicular to the surface of the substrate.

The compensation film 17 and 27 that may be used in the exemplary embodiment of the present invention is a compensation film used in the vertical alignment liquid crystal display.

This is because the liquid crystal has the biaxial characteristic, however the transmission characteristic of the biaxial liquid crystal is identically changed when viewing laterally compared with the front.

The characteristics of the compensation films 17 and 27 may be diverse according to the characteristics of each liquid crystal panel, and they compensate to wholly cause a uniform refractive index for each direction of the x axis, the y axis, and the z axis.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display comprising:
a thin film transistor array panel;
a counter display panel facing the thin film transistor array panel; and
a liquid crystal layer disposed between the thin film transistor array panel and the counter display panel, the liquid crystal layer including biaxial nematic liquid crystal molecules,
wherein a pixel area for displaying images includes a transmissive region and a reflective region, and a phase difference value of the liquid crystal layer in the reflective region is in a range of from 25% to 75% of a phase difference value of the liquid crystal layer in the transmissive region.

2. The liquid crystal display of claim 1, wherein
the phase difference value of the liquid crystal layer in the reflective region is one half of the phase difference of the liquid crystal layer in the transmissive region.

3. The liquid crystal display of claim 1, wherein
at least one of the cell gap, the magnitude of the pixel voltage, and the direction of the electric field for the liquid crystal rubbing direction is different between the reflective region and the transmissive region.

4. The liquid crystal display of claim 1, further comprising:
a first thin film transistor and a second thin film transistor disposed in the pixel area;
a first pixel electrode connected to the first thin film transistor, the first pixel electrode having a comb shape and being disposed in the reflective region; and
a second pixel electrode connected to the second thin film transistor, the second pixel electrode having a comb shape and being disposed in the transmissive region,
wherein the first pixel electrode and the second pixel electrode are parallel to each other, and
further comprising a common electrode in the pixel area, wherein the common electrode includes portions parallel to the first pixel electrode and the second pixel electrode and disposed between the first and second pixel electrodes.

5. The liquid crystal display of claim 1, further comprising:
a thin film transistor formed in the pixel area; and
first pixel electrodes disposed in the reflective region and second pixel electrodes disposed in the transmissive region,
wherein the second pixel electrodes are connected to the thin film transistor, and
the first pixel electrodes and the second pixel electrodes are respectively capacitively coupled to each other.

6. The liquid crystal display of claim 5, further comprising
connecting electrodes connected to the second pixel electrodes,
wherein the connecting electrodes and the first pixel electrodes are overlapped with each other for the capacitive coupling.

7. The liquid crystal display of claim 1, further comprising
a thin film transistor, pixel electrodes, and common electrodes formed in the pixel area,
wherein the pixel electrodes include a transmissive region portion disposed in the transmissive region and a reflective region portion disposed in the reflective region,
wherein the common electrodes include a transmissive region portion disposed in the transmissive region and a reflective region portion disposed in the reflective region, and
wherein the reflective region portions of the pixel electrodes and the common electrodes are not perpendicular or parallel with respect to the edges of the pixel area, and they form a predetermined angle.

8. The liquid crystal display of claim 7, wherein
the transmissive region portions of the pixel electrodes and the common electrodes are perpendicular or parallel with respect to the edges of the pixel area.

9. The liquid crystal display of claim 7, wherein
the reflective region portions of the pixel electrodes and the common electrodes are parallel to each other, and
the transmissive region portions of the pixel electrodes and the common electrodes are parallel to each other.

10. The liquid crystal display of claim 1, further comprising
a reflector having a plurality of openings and formed on one of the thin film transistor array panel and the counter display panel.

11. The liquid crystal display of claim 10, wherein
the openings define the transmissive region.

12. The liquid crystal display of claim 10, further comprising:
upper and an lower polarizers attached on the outer surface of the thin film transistor array panel and the counter display panel; and
a first λ/4 plate that is an upper potion of the reflector and is formed in the reflection region.

13. The liquid crystal display of claim 12, wherein
the upper polarizer and the lower polarizer include a transmissive axis, and the transmissive axis of the upper polarizer is perpendicular to the transmissive axis of the lower polarizer, and
the first λ/4 plate includes a slow axis, and the slow axis of the first λ/4 plate forms 45 degrees with the transmissive axis of the upper and lower polarizers.

14. The liquid crystal display of claim 13, further comprising
a compensation film attached on at least one between the thin film transistor array panel and the lower polarizer, and the counter display panel and the upper polarizer.

15. The liquid crystal display of claim 14, wherein
the compensation film has a slow axis parallel to the transmissive axis of the polarizer close to the compensation film.

16. The liquid crystal display of claim 10, further comprising:
upper and lower polarizers attached on the outer surface of the thin film transistor array panel and the counter display panel;
a first λ/4 plate that is above the reflector and is formed on the reflective region and the transmissive region; and
a second λ/4 plate that is below the reflector and formed on the transmissive region.

17. The liquid crystal display of claim 16, wherein:
the upper polarizer and the lower polarizer have a transmissive axis, and the transmissive axis of the upper polarizer is perpendicular to the transmissive axis of the lower polarizer;
the first λ/4 plate and the second λ/4 plate have a slow axis, and the slow axis of the first λ/4 plate is perpendicular to the slow axis of the second λ/4 plate; and
the slow axis of the first and second λ/4 plates forms 45 degrees with the transmissive axis of the upper and lower polarizers.

18. The liquid crystal display of claim 17, wherein
a compensation film is attached on at least one between the thin film transistor array panel and the lower polarizer, and the counter display panel and the upper polarizer.

19. The liquid crystal display of claim 18, wherein
the compensation film is attached between the second λ/4 plate and the lower polarizer.

20. The liquid crystal display of claim 18, wherein
the compensation film has a slow axis parallel to the transmissive axis of the polarizer close to the compensation film.

21. A liquid crystal display comprising:
a thin film transistor array panel;
a counter display panel facing the thin film transistor array panel; and
a liquid crystal layer formed between the thin film transistor array panel and the counter display panel and including biaxial liquid crystal molecules,
wherein a pixel area displaying images includes a transmissive region and a reflective region, and a phase difference value of light for displaying images in the reflective region is the same as a phase difference value of light for displaying images in the transmissive region with respect to one pixel.

22. The liquid crystal display of claim 21, wherein,
when the liquid crystal layer is applied with a predetermined voltage, the voltage applied to the reflective region is different from the voltage applied to the transmissive region in one pixel for the value of the transmittance of the light in the transmissive region with the same as the value of the transmittance of the light in the reflective region.

23. The liquid crystal display of claim 22, further comprising
an inner λ/4 plate formed between the thin film transistor array panel and the counter display panel, and at least formed in the reflective region.

24. The liquid crystal display of claim 4, further comprising
a reflector having a plurality of openings and formed on one of the thin film transistor array panel and the counter display panel,
wherein the openings define the transmissive region.

25. The liquid crystal display of claim 24, further comprising:
upper and an lower polarizers attached on the outer surface of the thin film transistor array panel and the counter display panel; and
a first λ/4 plate that is an upper potion of the reflector and is formed in the reflection region,
wherein
the upper polarizer and the lower polarizer include a transmissive axis, and the transmissive axis of the upper polarizer is perpendicular to the transmissive axis of the lower polarizer, and
the first λ/4 plate includes a slow axis, and the slow axis of the first λ/4 plate forms 45 degrees with the transmissive axis of the upper and lower polarizers.

26. The liquid crystal display of claim 25, further comprising
a compensation film attached on at least one between the thin film transistor array panel and the lower polarizer, and the counter display panel and the upper polarizer,
wherein the compensation film has a slow axis parallel to the transmissive axis of the polarizer close to the compensation film.

27. The liquid crystal display of claim 24, further comprising:
upper and lower polarizers attached on the outer surface of the thin film transistor array panel and the counter display panel;
a first λ/4 plate that is above the reflector and is formed on the reflective region and the transmissive region; and
a second λ/4 plate that is below the reflector and formed on the transmissive region,
wherein
the upper polarizer and the lower polarizer have a transmissive axis, and the transmissive axis of the upper polarizer is perpendicular to the transmissive axis of the lower polarizer;
the first λ/4 plate and the second λ/4 plate have a slow axis, and the slow axis of the first λ/4 plate is perpendicular to the slow axis of the second λ/4 plate; and
the slow axis of the first and second λ/4 plates forms 45 degrees with the transmissive axis of the upper and lower polarizers.

28. The liquid crystal display of claim 27, wherein
a compensation film is attached on at least one between the thin film transistor array panel and the lower polarizer, and the counter display panel and the upper polarizer, and
wherein the compensation film has a slow axis parallel to the transmissive axis of the polarizer close to the compensation film.

29. The liquid crystal display of claim 5, further comprising
a reflector having a plurality of openings and formed on one of the thin film transistor array panel and the counter display panel,
wherein the openings define the transmissive region.

30. The liquid crystal display of claim 29, further comprising:
upper and an lower polarizers attached on the outer surface of the thin film transistor array panel and the counter display panel; and
a first λ/4 plate that is an upper potion of the reflector and is formed in the reflection region,
wherein
the upper polarizer and the lower polarizer include a transmissive axis, and the transmissive axis of the upper polarizer is perpendicular to the transmissive axis of the lower polarizer, and
the first λ/4 plate includes a slow axis, and the slow axis of the first λ/4 plate forms 45 degrees with the transmissive axis of the upper and lower polarizers.

31. The liquid crystal display of claim 30, further comprising
a compensation film attached on at least one between the thin film transistor array panel and the lower polarizer, and the counter display panel and the upper polarizer,
wherein the compensation film has a slow axis parallel to the transmissive axis of the polarizer close to the compensation film.

32. The liquid crystal display of claim 29, further comprising:
upper and lower polarizers attached on the outer surface of the thin film transistor array panel and the counter display panel;
a first λ/4 plate that is above the reflector and is formed on the reflective region and the transmissive region; and
a second λ/4 plate that is below the reflector and formed on the transmissive region,
wherein
the upper polarizer and the lower polarizer have a transmissive axis, and the transmissive axis of the upper polarizer is perpendicular to the transmissive axis of the lower polarizer;
the first λ/4 plate and the second λ/4 plate have a slow axis, and the slow axis of the first λ/4 plate is perpendicular to the slow axis of the second λ/4 plate; and
the slow axis of the first and second λ/4 plates forms 45 degrees with the transmissive axis of the upper and lower polarizers.

33. The liquid crystal display of claim 32, wherein
a compensation film is attached on at least one between the thin film transistor array panel and the lower polarizer, and the counter display panel and the upper polarizer, and
wherein the compensation film has a slow axis parallel to the transmissive axis of the polarizer close to the compensation film.

34. The liquid crystal display of claim 7, further comprising
a reflector having a plurality of openings and formed on one of the thin film transistor array panel and the counter display panel,
wherein the openings define the transmissive region.

35. The liquid crystal display of claim 34, further comprising:
upper and an lower polarizers attached on the outer surface of the thin film transistor array panel and the counter display panel; and
a first λ/4 plate that is an upper potion of the reflector and is formed in the reflection region,
wherein
the upper polarizer and the lower polarizer include a transmissive axis, and the transmissive axis of the upper polarizer is perpendicular to the transmissive axis of the lower polarizer, and
the first λ/4 plate includes a slow axis, and the slow axis of the first λ/4 plate forms 45 degrees with the transmissive axis of the upper and lower polarizers.

36. The liquid crystal display of claim 35, further comprising
a compensation film attached on at least one between the thin film transistor array panel and the lower polarizer, and the counter display panel and the upper polarizer,
wherein the compensation film has a slow axis parallel to the transmissive axis of the polarizer close to the compensation film.

37. The liquid crystal display of claim 34, further comprising:
upper and lower polarizers attached on the outer surface of the thin film transistor array panel and the counter display panel;
a first λ/4 plate that is above the reflector and is formed on the reflective region and the transmissive region; and
a second λ/4 plate that is below the reflector and formed on the transmissive region,
wherein
the upper polarizer and the lower polarizer have a transmissive axis, and the transmissive axis of the upper polarizer is perpendicular to the transmissive axis of the lower polarizer;
the first λ/4 plate and the second λ/4 plate have a slow axis, and the slow axis of the first λ/4 plate is perpendicular to the slow axis of the second λ/4 plate; and
the slow axis of the first and second λ/4 plates forms 45 degrees with the transmissive axis of the upper and lower polarizers.

38. The liquid crystal display of claim 37, wherein
a compensation film is attached on at least one between the thin film transistor array panel and the lower polarizer, and the counter display panel and the upper polarizer, and
wherein the compensation film has a slow axis parallel to the transmissive axis of the polarizer close to the compensation film.
